(19) United States
(12) Patent Application Publication
(10) Pub. No.: US 2012/0186560 A1
(43) Pub. Date: Jul. 26, 2012

(54) HOMOGENIZING FUEL ENHANCEMENT SYSTEM

(75) Inventor: Morten A. LUND, Vista, CA (US)

(73) Assignee: EXEN HOLDINGS, LLC, Escondido, CA (US)

(21) Appl. No.: 13/436,035

(22) Filed: Mar. 30, 2012

Related U.S. Application Data
(63) Continuation-in-part of application No. 12/702,252, filed on Feb. 8, 2010.
Application No. 12/702,252 is a continuation of application No. PCT/US2010/051167, filed on Oct. 1, 2010.
Application No. PCT/US2010/051167 is a continuation of application No. 12/702,252, filed on Feb. 8, 2010.
(60) Provisional application No. 61/247,831, filed on Oct. 1, 2009.
(60) Provisional application No. 61/150,704, filed on Feb. 6, 2009.

(51) Int. Cl. F02M 21/02; F02M 37/04

(52) U.S. Cl. 123/495; 123/525

(57) ABSTRACT

A homogenizing fuel enhancement system involves at least one circulation loop existing outside of the injection system for continuously circulating and maintaining the homogeneity of a multi-fuel mixture apart from any demands by or delivery to the engine's injection system (whether mechanical injection or a common rail), and at least one infusion tube configured within the at least one circulation loop for providing a volumetric expansion wherein the fuel mixture is infused and thereby rendered more homogeneous.

### RELATED APPLICATIONS

This application is a Continuation In Part of U.S. patent application Ser. No. 12/702,252 filed on Feb. 8, 2010, which claims priority to U.S. Provisional Application No. 61/150,704 Filed on Feb. 6, 2009; and is a Continuation of International Application PCT/US2010/051167 filed on Oct. 1, 2010, which claims priority to U.S. Provisional Application No. 61/247,831 filed on Oct. 1, 2009, and to U.S. patent application Ser. No. 12/702,252 filed on Feb. 8, 2010. The entire content of each of which is hereby incorporated by reference in its entirely.

### INCORPORATION BY REFERENCE

Applicant(s) hereby incorporate herein by reference any and all U.S. patents and U.S. patent applications cited or referred to in this application. Specifically, Applicant(s) hereby incorporate herein by reference the entire contents of International patent application Ser. No. PCT/US2006/045399 filed on Nov. 24, 2006, and entitled “A Multi Fuel Co Injection System for Internal Combustion and Turbine Engines,” U.S. provisional patent application Ser. No. 61/055,965 filed on May 23, 2008, and Ser. No. 61/057,199 filed on May 29, 2008, both entitled “Multi-Fuel Co-Injection System and Method of Use,” and U.S. provisional patent application Ser. No. 61/150,704 filed on Feb. 6, 2009, and entitled “Homogenizing Fuel Enhancement System.” Accordingly, it is to be understood that any of the embodiments or features disclosed in the incorporated applications or their equivalents may be substituted for or employed in connection with those exemplary embodiments disclosed in the present application, in whole or in part, without departing from the spirit or scope of the invention.

### TECHNICAL FIELD

Aspects of this invention relate generally to fuel systems, and more particularly to enhanced fuel systems operating with multi-fuel mixtures.

### BACKGROUND ART

The following art defines the present state of this field:

By way of background, efforts over the past several decades abound directed to various means by which the efficiency of internal combustion engines may be improved or the emissions of such engines reduced. Some of these efforts have focused on the actual engine design, and particularly the fuel delivery, injection, and combustion systems and processes, while other efforts have been directed to improvements to the fuels themselves to somehow increase their combustion effect or the efficiency and uniformity with which they burn and hence the power derived therefrom and/or the reduced emissions resulting from a “cleaner” combustion process. The present application is primarily concerned with the former category of improvements to the fuel system itself, there being presented herein a number of new and improved homogenizing fuel systems and system components, the benefits of which will be readily apparent.

As to the prior art, in sum, all known efforts to increase the efficiency of internal combustion engines have to date led to only marginal success at best. Most such “improvements” have resulted in only a slight increase in actual efficiency and/or were achieved using approaches that are technologically or practically not workable, as either involving fuels that are not readily available or safely used or systems and hardware that add tremendous cost and complexity to the engine. As an example, currently much work is being done in the art in connection with homogeneous charge compression ignition (“HCCI”). In ideal “laboratory-type” usage, efficiency gains on the order of thirty percent (30%) are being seen in gasoline internal combustion engines using HCCI. However, due to the sensitive nature of this approach to combustion and its requirement of precise temperature and pressure conditions (compression ratios) in the combustion chambers for the automatic combustion reaction to be set off, under actual road testing where an engine is subjected to various loading demands, the HCCI process breaks down, leading not only to little to no efficiency gains but in some cases to engine failures (predetonation).

Other attempts to improve the efficiency and/or reduce emissions of internal combustion engines have included fuel fractioning, additives in the air intake, which thus don't interact with the fuel until they meet in the combustion chamber, and actual fuel additives or formulations introduced into the combustion chamber in some fashion that for a variety of reasons are relatively less effective given the particular system or implementation method.

First, as to the prior art fuel fractioning approach, generally, a number of references teach on-board fractioning, or separating a fuel into light and heavy distillates, for example, or otherwise conditioning a fuel for varied use depending on the demands of the engine, such as at start-up versus idle versus high RPM's, high or low load, or “warmed” operation. U.S. Pat. Nos. 2,758,579 to Pinotti and 2,865,345 to Hilton, commonly assigned and dating to the 1950's, teach systems wherein a liquid residual fuel and a liquid distillate fuel are proportionately mixed and delivered through mechanical metering to the engine. In terms of mixing the fuel fractions, Hilton teaches an “orifice mixer 32,” which is generally defined in the art as an “arrangement in which two or more liquids are pumped through an orifice constriction to cause turbulence and consequent mixing action,” while Pinotti teaches passage of the fuel fractions through a proportioning valve 5 and then on to the closed loop injection circulating system where the mixture is maintained “in an agitated or turbulent condition through header 23 against the back pressure of relief valve 25.” Both Pinotti and Hilton further involve residual and/or distillate fuel heaters to adjust through heat the viscosity of one or more of the fuel fractions to facilitate processing of the fuel mixtures, particularly during cold starting.

More recently, U.S. Pat. No. 6,067,969 to Kemmler et al. teaches a fuel supply system for an internal combustion engine with a fuel tank for liquid fuel, from which a fuel supply line leads to a fuel injection device, and an evaporating and condensing device for low-boiling fuel components also connected to the fuel tank. Also provided is an intermediary condensate tank connected downstream from the evaporating and condensing device, from which tank a condensate line leads to a control valve that regulates supply to the injection device. A residual fuel line for the high-boiling fuel produced in the evaporating and condensing device ends in an additional tank, from which a residual fuel supply line runs to a reversing valve mounted in the fuel supply line. The reversing valve is controlled so that the high-boiling fuel is supplied from the residual fuel supply line into the fuel supply line going to an injection device of the engine. Kemmler states that “[u]sing shuttle valve 3 and reversing valve 6, it can be ensured that the engine is supplied with the best possible fuel components for optimum operation by selectively feeding it with fuel, i.e., original fuel, low-boiling fuel from condensate line 15, or high-octane residual fuel from residual fuel line 22.”

Similarly, U.S. Pat. Nos. 6,571,748 and 6,622,664 to Holder et al. teach a fuel fractioning system as part of a fuel supply system for an internal combustion engine having a fuel tank for liquid fuel, a fuel pump that draws fuel from the fuel tank and pressurizes the fuel to an injection pressure at which the fuel is made available to the internal combustion engine, a fuel-fractionating device, which is preferably in the form of an evaporator or evaporation chamber and that produces at least one liquid fuel fraction from the fuel, and an accumulator that receives the liquid fuel fraction from the fuel-fractionating device, stores it, and makes it available to the internal combustion engine, the fuel and fuel fraction being fed to the internal combustion engine by the fuel supply system as a function of demand, with the accumulator being a pressure accumulator and including a pressure-generating means for pressurizing the fuel fraction in the pressure accumulator up to the injection pressure. In a further embodiment, the fuel and the fractions are mixed in a mixing chamber according to a performance graph stored in a control unit depending on the operating state of the engine and the mixture is then supplied to the engine in a controlled manner. Holder states in the '664 patent that “[a]s far as the inventive concept is concerned it is unimportant whether the fuel fractions are present in gaseous or liquid form,” yet it is also stated that “the fuel mixture [is injected] into the individual combustion chambers of the internal combustion engine in the conventional manner,” such that Holder effectively does not teach or enable injection of a liquid-gaseous fuel mixture. Rather, Holder discloses a fuel system that splits a liquid fuel into at least two fractions on board, such as a relatively high and relatively low boiling point fraction as through vacuum evaporation, which fractions are then mixed in a manner or ratio that “is optimal for the momentary engine operating state,” such that a dynamic or continuously variable fuel mix is required in the invention, much like Kemmler in this respect. Holder's primary objective appears to be emissions control.

And even more recently in connection with fuel fractioning systems, U.S. Pat. Nos. 7,028,672 and 7,055,511 to Glenz et al. teach a fuel supply system for an internal combustion engine having two separate storage containers for liquid fuels, both connected to a first controllable valve that is connected, via a connecting line including a fuel pump, to an inlet of a second controllable valve having two outlets in communication by separate fuel lines with a fuel injection nozzle of the internal combustion engine, each of the two separate fuel lines including a fuel pressure regulator, one being in communication with one and the other with the other of the two separate fuel storage containers for returning excess fuel to the fuel storage container from which fuel is being supplied to the fuel injection nozzle. Specifically, the Glenz systems are directed to delivering alternating liquid fuels to one injector of the engine at a time as derived from a fuel fractionation unit and pushed into the injectors as by compressed air or other gas, which is a similar approach to the well-known original Rudolph Diesel injection practice. Like Holder, the focus of Glenz is also emissions reduction, with specific emphasis on the start-up or warm-up phases of engine operation, and particularly on the on-board mixing and controlled use of optimized “starting” and “main” fuel mixtures as produced by the fuel fractionation unit.

Regarding prior art fuel fractioning systems, then, it will be appreciated that there is taught only liquid fuel or fuel fraction co-mixtures that are then introduced to the engine's fuel injection system typically in a controlled, variable manner to adjust to the demands of the engine while still reducing emissions, such as when cold starting and the like, without any teaching or suggestion that a circulation loop and/or volumetric expansion device would exist outside the fuel injection system as part of the overall fuel delivery system of the engine wherein co-mixtures of liquid and gaseous fuels would be sufficiently mixed and maintained in such a substantially homogeneous state of mixture until being delivered to the engine's fuel injection system for better atomization of the fuel mixture upon injection and thus more efficient combustion.

Turning to the introduction of a fuel additive such as propane or hydrogen through the air intake rather than in the fuel stream, there are known in the art a number of approaches whereby such an additive enters the combustion chamber as part of the air flow. For example, U.S. Pat. No. 7,019,626 to Funk teaches systems, methods and apparatuses of converting an engine into a multi-fuel engine in which some of the combusted gasoline or diesel fuel is replaced in the combustion chamber by the presence of a second fuel such as natural gas, propane, or hydrogen introduced through the air intake or separately directly into the combustion chamber. The Funk system includes a control unit for metering the second fuel and a passenger compartment indicator that indicates how much second fuel is being combusted relative to the diesel or gasoline. Funk indicates that the purpose of the invention is to address the emissions shortcomings of diesel engines and states that the various embodiments disclosed reduce particulate emissions while providing “an inexpensive diesel or gasoline engine conversion method and apparatus that informs the operator of the amount of alternative fuel that is being combusted.”

In Korean Patent Application Publication No. KR 2004/015646A, Bai teaches that liquid and gaseous fuels are mixed and then immediately passed into the combustion chamber through the air intake. Specifically, Bai discloses a jet mixer 1 comprising a gas and liquid fuel mixing pipe 15 arranged at the ends of a gas fuel supply pipe 11 and a liquid fuel supply pipe 13 so as to mix the fuels supplied from the supply pipes, wherein the gas and liquid fuel mixing pipe 15 has outlet holes and a fuel filter 17 is spaced from the mixing pipe 15 to filter off large particles from the mixed fuel, which then passes through a mixed fuel supply pipe 19 to the engine.

Clearly, in any such case where a fuel additive is introduced into the combustion chamber by way of the air intake, or even by being injected separately from the primary liquid fuel, more about which is said below in connection with further prior art examples, there is provided no means by which the primary and secondary fuels, or liquid and gaseous fuels, are able to sufficiently mix together prior to the injection and combustion events.

Turning now to the introduction of a fuel additive such as propane or hydrogen in the fuel stream, specifically, U.S. Pat. No. 6,845,608 to Klenk et al. teaches a method for operating an internal combustion engine in which at least two different fuels are simultaneously supplied to at least one combustion chamber of the internal combustion engine. More specifically, Klenk discloses the injection of hydrogen along with diesel fuel through a common injector primarily for the purpose of emissions reduction, just as for most of the “fuel fractioning” prior art discussed above. Similarly, U.S. Pat. No. 6,427,660 to Yang teaches a compression ignition internal combustion engine 7 with at least one combustion chamber 10 having an air inlet 14 and an exhaust outlet 26 with a dual fuel injector being provided having a mixing chamber 46 with an outlet fluidly connected with the combustion chamber 10 via a first valve 54. A liquid fuel line 64 is provided for delivering liquid fuel to the mixing chamber 46. The liquid fuel line 64 is connected to the mixing chamber 46 via a second valve 60. A combustible gas line 56 is provided for delivering compressed combustible gas to the mixing chamber 46. Upon an opening of the first valve 54, the liquid fuel is brought into the combustion chamber 10 by the compressed combustible gas. It is thus clear from such prior art that there is shown only liquid and gaseous fuels essentially being co-injected without any means for sufficiently mixing the additive and the base fuel prior to injection.

Other approaches in the art of bringing together multiple fuels as a common stream even ahead of injection yet involve further disadvantageous features and still without providing a desirable means to substantially homogeneously mix particularly liquid and gaseous fuels and maintain such homogeneity prior to injection. For example, U.S. Pat. No. 6,513,505 to Watanabe et al. teaches injectors 2 that are connected to a common rail 4 via respective dispensing conduits 3 and a mixture of a liquid fuel fed from a liquid fuel tank 2 and an additional fluid fed from an additional fluid tank 9 that is then fed to the common rail 4. The additional fluid contained in the mixture is turned to its supercritical state, and the mixture is injected from the injectors 2 to the engine. The inlets of the dispensing conduits 3 are positioned, with respect to the common rail 4, to open out into a liquid fuel layer which will be formed in the common rail 4 when a separation of the mixture occurs. Thus, while teaching that the fuel components, such as diesel or light oil and an additive such as water, carbon dioxide, hydrogen, and hydrocarbon such as alcohol, methane and ethane, can even be mixed upstream of the fuel injection system, here in a choke 12 in line ahead of the injection pump 6, Watanabe further discloses only that the additional fluid be at all times kept in its supercritical state, which is generally defined as being at a temperature and pressure above its thermodynamic critical point, or having characteristics of both a liquid and a gas. To maintain such a supercritical state of the fuel additive, Watanabe teaches maintaining the temperature “lower than the critical temperature T_{c} of the additional fluid” and the pressure “higher than the vaporizing (liquefying) pressure of the additional fluid” in the fuel line all the way from the additive tank 9 to the pressurizing pump 6. To do so introduces a number of complexities and attendant costs to the Watanabe system. Moreover, maintaining and dealing with these finely balanced physical fuel properties presents further challenges within the injection system, and the common rail 4, specifically. The vertically oriented common rail 4 in Watanabe is expressly configured not only to maintain specific temperatures and pressures but also to allow, as when the engine is off, for separation of the additional fluid, namely the gaseous fuel such as natural gas or methane, from the primary liquid fuel such as diesel, with the diesel occupying the bottom space of the common rail so as to be injected first until the common rail warms up, the additional fluid returns to its supercritical state, and the two fuel components then re-mix to some extent until “finally the two layers in the common rail 4 would disappear.” Therefore, it is clear that Watanabe introduces relatively costly and complex features in its “fuel feeding device” in an effort to maintain the additional fluid in a supercritical or liquid state, which Watanabe indicates is necessary to achieve sufficient mixing with the primary fuel, even expressly teaching that “if the additional fluid vaporizes before it is mixed with the liquid fuel, or before it is turned to its supercritical state even after it is mixed with the liquid fuel, the liquid fuel and the additional fluid cannot mix with each other uniformly.” Watanabe goes on to say that “[i]f the additional fluid vaporizes, the volume thereof increases. Therefore, it is difficult to feed the additional fluid sufficiently.” Thus, Watanabe clearly teaches that the fuel constituents must be kept in a liquid or supercritical state essentially throughout the system while in operation using temperature and pressure in order to adequately mix and later inject the liquid fuel mixture.

Similarly, and in yet another category of prior art multi-fuel systems, there is taught a reverse approach where the gaseous fuel component such as propane becomes the primary combustible fuel and the liquid fuel such as diesel is a secondary ignition or combustion catalyst. For example, International Publication No. WO 2008/141390 to Martin discloses an injection system for a high vapor pressure liquid fuel such as liquefied petroleum gas (i.e., LPG or propane) that “keeps the fuel liquid at all expected operating temperatures” by use of a high pressure pump capable of at least 2.5 MPa pressures. The fuel can be injected directly into the cylinder or into the inlet manifold of an engine via axial or bottom feed injectors and also could be mixed with a low vapor pressure fuel (e.g. diesel) to be injected similarly. The fuel, mixed or unmixed, can be stored in an accumulator under high pressure assisting in keeping the engine running during fuel changeovers and injection after a period of time as in re-starting the engine. The same injectors can be used to inject any of the fuels or mixtures of them. Therefore, like Watanabe and others, Martin also teaches the desirability of maintaining all fuel constituents at all times as liquids to facilitate mixing and other processing of the fuel before and during injection.

In U.S. Patent Application Publication No. US 2008/0022965 to Bysveen et al., there is taught a compression ignition internal combustion engine that operates using a methane-based fuel and again diesel or the like as an “ignition initiator.” The fuel and method of operating the engine can be employed in a range of applications such as, for example, road or marine vehicles or in static applications such as electrical generators. Just as with Watanabe and Miller, Bysveen teaches that the “[g]as fuel is pressurized or liquefied and mixed with [the diesel fuel],” here off-board of the engine or vehicle, and then “[t]he pre-mixed fuel 3 is fed into a storage vessel 4 which maintains the fuel in a pressurized or liquid state.” In an alternative embodiment of Bysveen, “the injector 206 is arranged to receive the two fuel components and to introduce them simultaneously into the combustion chamber.” Here, much like Klenk, for example, “[t]he two components are mixed in the injector immediately before injection into [the] combustion chamber ensuring a uniform dispersion of ignition initiator in the pressurized or liquefied gas.” Accordingly, there is no fuel re-pressurization in Bysveen, Klenk and other such systems, whereby only common rail rather than direct or mechanical injection may be employed, otherwise there may be pump cavitations, and, in the case of Bysveen, additional hardware in the form of specifically-engineered hydraulic injectors is still needed to insure that the liquid-gaseous fuel mixture is adequately injected (that is, that excess vapor formation that could lead to vapor lock is mitigated). Also like Klenk, Holder and others, Bysveen's primary aim is again emissions reduction rather than improved fuel efficiency.

Referring briefly to one further PCT patent application, analogous to Bysveen, International Publication No. WO 2008/036999 to Fisher teaches a dual fuel system and assembly where liquid LPG and diesel are mixed and then distributed via the common rail to the combustion chambers. With the preferred embodiment of the dual fuel system, Fisher asserts that only minor changes are required to the diesel engine without altering the manufacturers' specifications. According to Fisher, the resultant combustion of the liquid fuel mixture provides cleaner emissions and relatively cheaper vehicle operational costs due to essentially the use of a less expensive fuel, not a result of greater efficiency. In a bit more detail, Fisher teaches passive mixing of pre-pressurized liquid diesel and liquid propane in a mixing chamber 28 configured as a spherical reservoir with the respective fuel streams being introduced off-axis one to the other to create a swirling effect and thereby being “adapted to mix a proportioned flow of the liquefied gas and a proportioned flow of diesel to form a liquid fuel mixture.” A wire mesh 61 is placed in the mixing chamber 28 “to facilitate mixing of the fuels” or agitation. Fisher teaches that the liquid fuel mixture is “preferably pumped to a common rail under high pressure so that the liquid fuel mixture remains in a liquid state.” It follows that just as for Watanabe, Bysveen, Miller and others, Fisher also teaches that the liquid and gaseous fuels are to be in liquid state, as by being under sufficient pressure, at all points in the mixing and delivery process within the disclosed dual-fuel system. And as with others, Fisher would appear to again be only concerned with emissions reduction.

Thus, the prior art as summarized above includes various systems by which primarily diesel engines can be converted to operate in a “dual-fuel” or “multi-fuel” mode by fractioning the liquid fuel (Hilton, Pinotti, Kemmler, Holder, and Glenz), by adding another fuel constituent to the fuel stream (Klenk, Yang and Watanabe) or the air intake (Funk and Bai), or by effectively reversing the fuels and injecting a small amount of diesel into the combustion chamber as a catalyst or, in the words of Bysveen, an “ignition initiator,” sometimes known as a “pilot injection,” which ignites or combusts an alternative fuel such as natural gas, propane or hydrogen that was introduced into the combustion chamber through the air intake or directly into the chamber separately from or mixed under pressure with the diesel (Martin, Bysveen and Fisher). Certainly, in any such manner, a percentage of the diesel is replaced by such alternative fuels in the combustion event, resulting in lower exhaust emissions, especially particulate matter. This may also reduce fuel costs if the alternative fuels are cheaper than diesel, though not necessarily reducing overall fuel consumption or actually improving fuel efficiency. Some of the more recent approaches to multi-fuel injection as highlighted above do go so far as to suggest that such alternative fuels be mixed with the diesel fuel at some point upstream, prior to the injection event, but these other references teach that diesel remains a secondary fuel or “ignition initiator” in a small proportion relative to the alternative fuel and/or that specific physical states of the fuel components, such as supercritical or liquefied through sufficiently high pressures, be maintained at all times in order for the fuels to be satisfactorily mixed and co-injected (see Watanabe and also Ishikiriyama and Hibino below), or otherwise provide no teaching or structure for substantially homogeneously mixing the fuels prior to injection so as to improve the atomizing effect on the diesel or other primary fuel component of the mixture by the uniform dispersion therethrough of the gaseous, or lower boiling point, fuel component. Particularly regarding the means of mixing the liquid and gaseous fuel components, while a number of prior art references do mention a “mixing chamber,” an “orifice mixer,” a “jet mixer,” a “choke” or “venturi,” or a storage volume within the system having an “agitator” such as a mesh screen or mixing blade, none teach multiple chambers in series or otherwise any specific geometry or minimum volume sufficient to allow the gaseous fuel to substantially reach equilibrium or saturation within the liquid fuel before the multi-fuel mixture passes to the injection system.

Relative to further exemplary embodiments of the multi-fuel system of the present invention, beyond the art discussed above, there are a few additional prior art approaches that deserve mention, particularly as they relate to the use of nitrogen as a gaseous fuel additive in a liquid-gaseous multi-fuel mixture.

First, it is known in the art to use nitrogen, being an inert gas, as a detonation or combustion inhibitor within a fuel system. For example, in U.S. Pat. No. 6,634,598 to Susko there is taught the use of nitrogen in an appropriate proportion relative to oxygen in the space above the liquid fuel in an aircraft or other vehicle fuel tank so as to “not support combustion in the event of an ignition source or intrusion of another potentially explosive occurrence within [the] tank.” Susko discloses that the nitrogen would be sourced from a pressurized tank 13 in valved communication with the liquid fuel tank 11 and metered into the tank based on oxygen content in the tank as detected by a probe of some kind. Thus, in such contexts, it is clear that nitrogen is employed in a fuel system as a combustion inhibitor for safety rather than any kind of combustion enhancer, thereby teaching away from the use of nitrogen as an actual fuel additive. See also U.S. Patent Application Publication No. US 2007/0151454 to Marwitz et al. entitled “Mobile Nitrogen Generation Device,” paragraph 0005. Marwitz generally teaches a system to separate nitrogen from atmospheric air for the purpose of injecting the inert nitrogen into a borehole to prevent ignition and corrosion during drilling operations.

Traditionally, then, where nitrogen in any form has been incorporated into a liquid fuel itself rather than existing separate from and in the space above the fuel as an inerting agent, it has been taught as a chemical compound in the hydrocarbon fuel, for purposes other than combustion, rather than simply being mixed into the liquid fuel as “pure” nitrogen gas N₂. In U.S. Pat. No. 5,139,534 to Tomassen et al. and assigned to Shell Oil Company, there is taught “a diesel fuel additive for reducing fouling of injectors in diesel engines consisting of at least an effective concentration of a nitrogen-containing compound of the general formula CH₃(CH₂)-A—NH₂ wherein n is 4 to 18 and A is —CH₂— or —CO—, or a mixture thereof as an additive in a diesel fuel comprising a major proportion of a diesel oil.” Tomassen teaches that such an additive would be placed in admixture with the diesel fuel in the range of 10 to 500 parts per million by weight (ppmw), though it “may comprise a major (greater than 50% wt) or minor portion.” Ultimately, Tomassen again only discloses that any such additive would be a specific “nitrogen-containing compound,” not nitrogen gas, selected and proportioned for its effectiveness in preventing or removing fouling of the injectors, particularly the injector nozzles, not for any combustion effect.

U.S. Pat. No. 6,343,462 to Drnevich et al. teaches a gas turbine system in which “[p]ower output is enhanced and NOx emissions are lowered while heat rate penalties are minimized by adding nitrogen or a mixture of nitrogen and water vapor to the gas turbine in conjunction with the use of low pressure steam.” Drnevich does disclose that the stationery nitrogen source could be achieved through any air separation technology such as cryogenic distillation, pressure swing adsorption, vacuum pressure swing adsorption, or membrane technology and that the nitrogen could be high purity (less than 10 ppm oxygen) or lower purity (less than 5% oxygen). But Drnevich emphasizes that the nitrogen is moistened by steam at a pressure ranging from 30 psia to the gas turbine fuel delivery pressure and is superheated to avoid condensation before the moist nitrogen is then mixed with the primary fuel such as natural gas. That is, in the particular gas turbine application that Drnevich is concerned with, it is necessary that such moisturized nitrogen be mixed with the natural gas in almost equal portions (35% natural gas, 32.5% nitrogen, and the balance water vapor in the exemplary embodiment) in order to achieve the desired NOx reduction, the nitrogen particularly being employed for its cooling effect on the combustion reaction, which thereby reduces the formation of oxides of nitrogen. As such, the nitrogen in the gas turbine application of Drnevich serves essentially as a water vapor carrier. Once again, then, the nitrogen is being used in a manner and for a purpose other than combustion or atomization of the fuel, it being instead inert and that quality being availed in a cooling, non-reactive capacity. As stated by Drnevich, such use of nitrogen in gas turbines is known, whether injected separately into the compressor discharge and/or combustor or first mixed with the fuel that is then combusted.

Finally, referring now to a more recent invention for use expressly in conjunction with internal combustion engines operating on diesel or gasoline fuel, International Patent Application No. PCT/EP2007/058668 to Bert et al., published as International Publication No. WO 2009/024185, is directed to “on-board continuous hydrogen production via ammonia electrolysis.” Bert discloses that the particular electrolyzer “allows on-board generation of a hydrogen:nitrogen mixture to be used as [a] combustion promoter in an internal combustion engine where the primary fuel is either ammonia or any other fossil fuel, such as methane, gasoline and diesel.” Therefore, Bert teaches a specific hydrogen:nitrogen mixture (preferably in the ratio of 3:1) produced on-board, such that nitrogen as an inert gas is once again not taught as a stand-alone fuel additive, and in fact only as a byproduct of the hydrogen generation process and so produced here only in conjunction with hydrogen that is known to have potential energy and hence a combustive effect and also in connection with only adding such a hydrogen:nitrogen mixture in the air intake, not to a liquid fuel pre-injection.

Other prior art generally relating to the field of efficiency and/or emissions improvement in internal combustion engines includes the following:

U.S. Pat. No. 4,373,493 to Welsh teaches a method and apparatus for utilizing both a liquid fuel and a gaseous fuel with a minimum change in a standard internal combustion engine. The gaseous and liquid fuels are fed from separate fuel supplies with the flow of fuels being controlled in response to engine load so that at engine idle only gaseous fuel is supplied and combusted by the engine and both gaseous and liquid fuels are supplied and combusted when the engine is operating under load conditions.

U.S. Pat. No. 4,953,516 to van der Weide teaches a device for the intelligent control of a venturi-type carburetor unit for a gaseous fuel, including a pressure regulator, a main throttle valve in the air suction pipe for control of the engine output and a regulating valve in the gas supply pipe between the pressure regulator and the venturi, this valve being coupled to the main throttle valve. By adjusting this mechanical system for providing a too rich air-fuel-mixture under all conditions, only mirror adjustments of the mixture are necessary to provide the engine with the correct mixture required for each load/speed condition. These requirements are stored in a processor, and the latter controls the necessary corrections of the mixture by diluting the gas flow to the main venturi with some air. To this end a small venturi is placed in the gas pipe, the gas flow sucking the diluting air through a mixing air regulating valve, which valve is controlled by the processor in a continuous, Analogix intelligent way. Optionally an O₂-sensor placed in the exhaust gases may send feed-back signals to the processor.

U.S. Pat. No. 5,207,204 to Kawachi et al. teaches an engine having a combustion chamber and a fuel injection valve for directly injecting a fuel into the combustion chamber. An assist air supplying apparatus supplies assist air to atomize the fuel injected by the fuel injection valve. Assist air supply pressure is controlled so that a given pressure difference is secured between the assist air supply pressure and pressure in the combustion chamber. The assist air, therefore, is supplied under proper pressure for an entire period of fuel injection, to adequately micronize the injected fuel and improve combustion efficiency.

U.S. Pat. No. 5,291,869 to Bennett teaches a fuel supply system for providing liquified petroleum gas (“LPG”) fuel in a liquid state to the intake manifold of an internal combustion engine, including a fuel supply assembly and a fuel injecting mechanism. The fuel supply assembly includes a fuel rail assembly containing both supply and return channels. The fuel injecting mechanism is in fluid communication with the supply and return channels of the fuel rail assembly. Injected LPG is maintained liquid through refrigeration both along the fuel rail assembly and within the fuel injecting mechanism. Return fuel in both the fuel rail assembly and the fuel injecting mechanism is used to effectively cool the supply fuel to a liquid state prior to injection into the intake manifold of the engine.

U.S. Pat. No. 5,816,224 to Welsh et al. teaches a system for storing, handling, and controlling the delivery of a gaseous fuel to internal combustion engine powered devices adapted to run simultaneously on both a liquid fuel and a gaseous fuel. The invention provides a control system having a float controlled solenoid for ensuring that a consistent supply of dry gas is delivered to the engine. The invention uses the sensors and computer of the existing electronic fuel delivery system of the device to adjust the amount of liquid fuel delivery to compensate for the amount of gaseous fuel injection. The invention provides a gaseous fuel control system for a dual fuel device which is integrated and compact, and which preferably includes a fuel fill connection for the gaseous fuel. The invention also provides a horizontal fuel reservoir comprised of end interconnected parallel conduits and, preferably, includes two separate compartments and a pressure relief system for permitting expansion into a relief compartment from a main compartment. It also provides horizontal and vertical interchangeable reservoirs with expansion properties filled by weight.

U.S. Pat. No. 6,213,104 to Ishikiriyama teaches that the state of a liquid fuel such as diesel fuel is made a supercritical state by raising the pressure and the temperature of the fuel above the critical pressure and temperature. Then, the fuel is injected from the fuel injection valve into the combustion chamber of the engine in the supercritical state. When the fuel in the supercritical state is injected into the combustion chamber of the engine, it forms an extremely fine uniform mist in the entire combustion chamber. Therefore, the combustion in the engine is largely improved.

U.S. Pat. No. 6,235,067 to Ahern et al. teaches a scheme for combusting a hydrocarbon fuel to generate and extract enhanced translational energy. In the scheme, hydrocarbon fuel is nanopartitioned into nanometric fuel regions each having a diameter less than about 1,000 angstroms; and either before or after the nanopartitioning, the fuel is introduced into a combustion chamber. In the combustion chamber, a shock wave excitation of at least about 50,000 psi and with an excitation rise time of less than about 100 nanoseconds is applied to the fuel. A fuel partitioned into such nanometric quantum confinement regions enables a quantum mechanical condition in which translational energy modes of the fuel are amplified, whereby the average energy of the translational energy mode levels is higher than it would be for a macro-sized, unpartitioned fuel. Combustion of such a nanopartitioned fuel provides enhanced translational energy extraction by way of, e.g., a reciprocating piston because only the translational energy mode of combustion products appreciably contributes to momentum exchange with the piston. The shock wave excitation provided by the invention, as applied to combustion of any fuel, and preferably to a nanopartitioned fuel, enhances translational energy extraction and exchange during combustion by enhancing translational energy mode amplification in the fuel and by enhancing transfer of an appreciable amount of energy from that translational mode to the piston before the combusted fuel re-equilibrates the translational energy into other energy modes.

U.S. Pat. No. 6,584,780 to Hibino et al. teaches a system that stores densely dissolved methane-base gas and supplies gas of a predetermined composition. A container 10 stores methane-base gas dissolved in hydrocarbon solvent and supplies it to means for adjusting the composition, through which an object of regulated contents is obtained. Preferably, the means for adjusting the composition is means for maintaining the tank in a supercritical state, or piping 48 for extracting substances at a predetermined ratio from the gas phase 12 and liquid phase 16 in the container.

U.S. Pat. No. 6,761,325 to Baker et al. teaches a dual fuel injection valve that separately and independently injects two different fuels into a combustion chamber of an internal combustion engine. A first fuel is delivered to the injection valve at injection pressure and a second fuel is either raised to injection pressure by an intensifier provided within the injection valve, or delivered to the injection valve at injection pressure. Electronically controlled valves control hydraulic pressure in control chambers disposed within the injection valve. The pressure of the hydraulic fluid in these control chambers is employed to independently actuate a hollow outer needle that controls the injection of the first fuel. Disposed within the outer needle is an inner needle that controls the injection of the second fuel. The outer needle closes against a seat associated with the injection valve body and the inner needle closes against a seat associated with the outer needle.

U.S. Patent Application Publication No. US 2007/0169749 to Hoenig et al. teaches a fuel-injection system for injection of fuel into an internal combustion engine that includes at least one fuel injector and a first fuel-distributor line which is connected to the at least one fuel injector. A second fuel-distributor line is provided which is connected to the at least one fuel injector via an individual corresponding lance.

U.S. Patent Application Publication No. US 2008/0029066 to Futonagane et al. teaches a fuel injector (1) in an internal combustion engine, wherein an intermediate chamber control valve (26) operated by the fuel pressure in a common rail (2) is arranged in a fuel flow passage (25) connecting a two-position switching type three-way valve (8) and an intermediate chamber (20) of a booster piston (17). When the fuel pressure in the common rail (2) is in a high pressure side fuel region, the booster piston (17) is operated by this intermediate chamber control valve (26), while when the fuel pressure in the common rail (2) is in a low pressure side fuel region, the operation of the booster piston (17) is stopped by this intermediate chamber control valve (26).

Thus, the prior art as summarized above includes various systems by which primarily diesel engines can be converted to operate in a “dual-fuel” or “multi-fuel” mode by fractioning the liquid fuel, by adding another fuel constituent to the fuel stream or the air intake, or by effectively reversing the fuels and injecting a small amount of diesel into the combustion chamber as a catalyst. There is also taught the use of nitrogen in various capacities in conjunction with other primary fuels, but due to its inert nature either as a safety inerting agent, as a non-gaseous compound additive for anti-corrosive effects, or in combination with “fuels” other than nitrogen that provide mass or energy to the combustion event, such as water or hydrogen, but clearly never as a stand-alone fuel additive for combustive effect, whether produced on board or supplied from a pressurized tank.

What is still needed and has been heretofore unavailable is a relatively simple and cost-effective engine fuel enhancement system through which improved efficiencies can be achieved.

The present invention meets this need and provides further related advantages as described below.

### DISCLOSURE OF INVENTION

Aspects of the present invention teach certain benefits in construction and use which give rise to the exemplary advantages described below.

By way of overview, aspects of the invention relate to a homogenizing fuel enhancement system involving at least one circulation loop existing outside of the injection system for continuously circulating and maintaining the homogeneity of a multi-fuel mixture apart from any demands by or delivery to the engine's injection system (whether mechanical injection or a common rail), and at least one infusion tube configured within the at least one circulation loop for providing a volumetric expansion wherein the fuel mixture is able to slow and more sufficiently infuse and absorb, and thereby become relatively more homogeneous. Other variations on the configuration and quantity of these two components are possible without departing from the spirit and scope of the present invention. Further aspects of the present invention relate to a control system for controlling, among other things, the on-board metering, mixing and delivery of mixed fuel to the engine. Moreover, additional components may be interchangeably incorporated in any such homogenizing fuel enhancement system for added or ancillary functionality, such as an accumulator to account for pressure surges, and a fuel cooling means.

Other features and advantages of aspects of the present invention will become apparent from the following more detailed description, taken in conjunction with the accompanying drawings, which illustrate, by way of example, the principles of aspects of the invention.

### BRIEF DESCRIPTION OF DRAWINGS

The accompanying drawings illustrate aspects of the present invention. In such drawings:

FIG. 1 is a schematic of an exemplary embodiment of the invention;

FIG. 2 is a schematic of an alternative exemplary embodiment of the invention;

FIG. 3 is an enlarged side schematic of an exemplary homogenizing fuel apparatus according to aspects of the invention;

FIG. 4 is a top schematic thereof;

FIG. 5 is a bottom schematic thereof;

FIG. 6 is a side schematic thereof in use;

FIG. 7 is a schematic of a further alternative exemplary embodiment of the invention;

FIG. 8 is a schematic of a further alternative exemplary embodiment of the invention;

FIG. 9 is a schematic of a further alternative exemplary embodiment of the invention;

FIG. 10 is a schematic of a still further alternative exemplary embodiment of the invention;

FIG. 11 is a schematic of a still further alternative exemplary embodiment of the invention;

FIG. 12 is a schematic of a still further alternative exemplary embodiment of the invention;

FIG. 13 is an enlarged side schematic of an alternative exemplary homogenizing fuel apparatus according to aspects of the invention;

FIG. 14 is a schematic of a still further alternative exemplary embodiment of the invention;

FIG. 15 is a schematic of a still further alternative exemplary embodiment of the invention;

FIG. 16 is an enlarged side schematic of a further alternative exemplary homogenizing fuel apparatus according to aspects of the invention;

FIG. 17 is a flow schematic of three of the homogenizing fuel apparatuses of FIG. 16 installed in series;

FIG. 18 is an enlarged perspective view of an exemplary flow control apparatus according to aspects of the invention;

FIG. 19 is a cross-sectional view of the flow control apparatus of FIG. 18 taken along line 19-19;

FIG. 20 is a schematic of a still further alternative exemplary embodiment of the invention;

FIG. 21 is a schematic of a still further alternative exemplary embodiment of the invention; and

FIG. 22 is an enlarged side schematic of an exemplary capillary bleed device employed according to aspects of the invention.

### MODES FOR CARRYING OUT THE INVENTION

The above described drawing figures illustrate aspects of the invention in at least one of its exemplary embodiments, which aspects are further defined in detail in the following description.

The subject of this patent application is generally an improved fuel enhancement system in various embodiments for use in connection with internal combustion engines or the like that builds on the disclosures of the above-referenced applications. Thus, while the further exemplary embodiments shown and described herein are focused on specific aspects of particularly the fuel enhancement system components relating to the mixing, circulation, and delivery of the multi-fuel mixture, here specifically in the context of common rail or mechanical injection diesel engines, it will be appreciated by those skilled in the art that the present invention is applicable to and may work in conjunction with a variety of engines, engine fuel systems, and fuels now known or later developed or discovered and so is not limited to the particular embodiments shown and described. Furthermore, it is to be understood that the word “fuel” as used throughout the present application and the referenced prior applications encompasses any combustible substance or any substance that aids in, enhances or otherwise affects combustion in some way. Moreover, a “gaseous fuel” is to be understood as any such “fuel” substance that is in a gaseous state at atmospheric conditions, or at atmospheric pressure and zero degrees Celsius, such as air or propane, irrespective of the phases or states such a gaseous fuel may move through or be in at any particular point in an engine's fuel delivery system, injector, or combustion chamber, generally, or in the instant improved homogenizing fuel enhancement system, as will be appreciated from the more detailed explanation of aspects of the present invention set forth further below.

Generally, aspects of the present homogenizing fuel system involve at least one circulation loop existing outside of the injection system for continuously circulating and maintaining the homogeneity of a multi-fuel mixture apart from any demands by or delivery to the engine's injection system (whether mechanical injection or a common rail or other such system now known or later developed), and at least one infusion tube configured within the at least one circulation loop for providing a volumetric expansion wherein the fuel mixture is able to more sufficiently infuse and absorb and thereby become relatively more homogeneous. Other variations on these two components are possible without departing from the spirit and scope of the present invention. Further aspects of the homogenizing fuel enhancement system relate to a control system for controlling, among other things, the on-board metering, mixing and delivery of mixed fuel to the engine. Moreover, additional components may be interchangeably incorporated in any such homogenizing fuel system for added or ancillary functionality, such as an accumulator to account for pressure surges and a fuel cooling means.

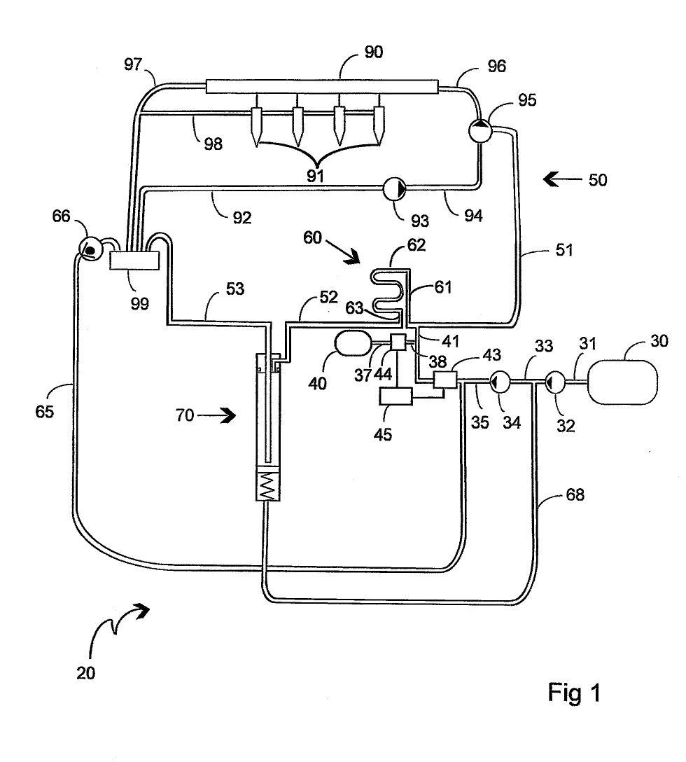

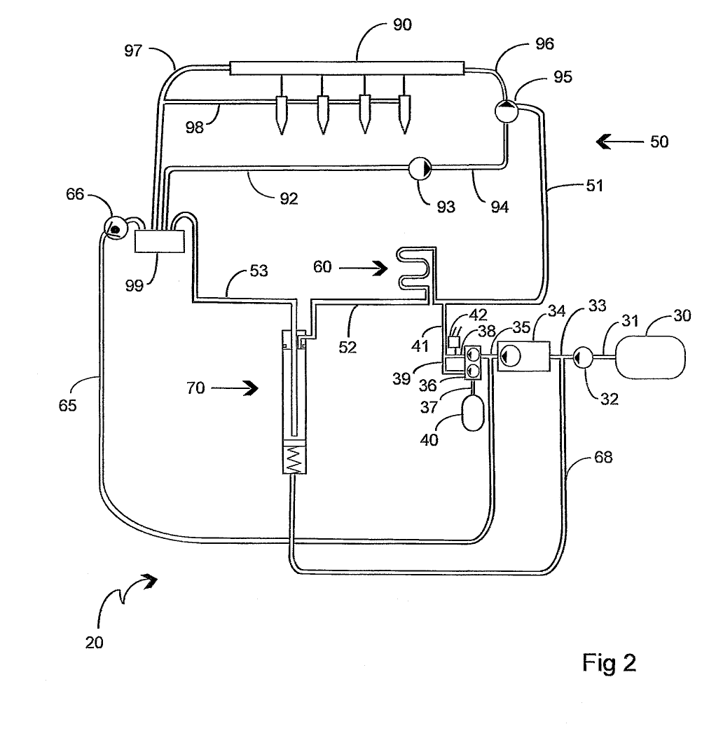

Referring first to FIGS. 1 and 2, there are shown schematics of exemplary embodiments of a homogenizing fuel enhancement system 20 according to aspects of the present invention for use in conjunction with a “common rail” diesel engine, the respective embodiments differing primarily in the fuel system control means—electrical versus mechanical—more about which will be said below. As a threshold matter, it is noted that while a number of engine components are shown as part of the figures generally throughout, such as the common rail or fuel gallery, the injectors, the fuel filter, the diesel tank and lift pump, and related fuel lines and the like, all such components or any variations thereof or substitutions therefor may be employed, whether factory-installed or after-market, in conjunction with the present invention without departing from its spirit and scope. Thus, while such components are shown in the various figures as part of the overall fuel system, it is to be understood that the invention is expressly not limited thereto and that no claim is made to such standard components of an engine, which are provided herein simply as context for the homogenizing fuel enhancement system of the present invention. Moreover, again, while the exemplary embodiments are specifically shown and described in connection with a diesel internal combustion engine, a variety of other engines now known or later developed may be employed, including but not limited to gasoline direct injection engines.

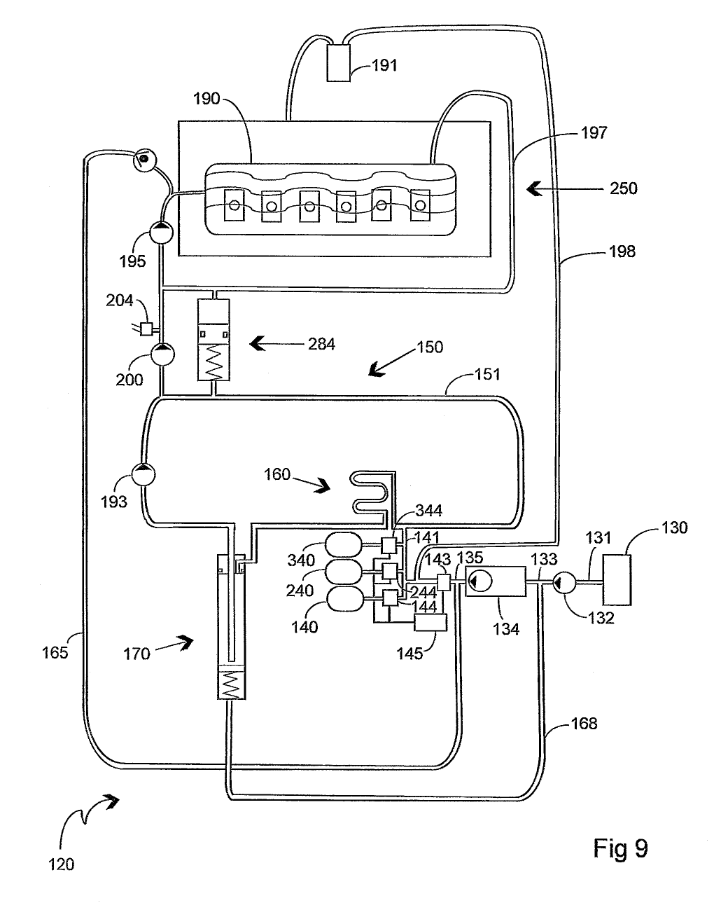

In the first exemplary embodiment of FIG. 1, there is shown an overall fuel system 20 generally including a diesel tank 30 with a lift pump 32 and a pressurized propane tank 40 both feeding into a circulation loop generally designated 50 and including an infusion tube 70, one or more of which defining a homogenizing fuel enhancement apparatus, the circulation loop 50 being in fluid communication with the engine's injection system common rail 90 and injectors 91, here by way of the fuel filter 99. In more detail, the diesel tank 30 supplies diesel fuel through a fuel line 31 by way of the lift pump 32 at about 5 psi, all of which are factory-installed equipment that could be self-contained within the tank 30 or separately configured as shown for convenience in FIG. 1. The diesel fuel then passes via fuel line 33 to a further circulation loop delivery pump 34 that takes the diesel fuel up to approximately 15-20 psi in the exemplary embodiment. It will be appreciated that the circulation loop delivery pump 34 may be any fluid pump now known or later developed and configured for appropriate pressures and power draw and to accommodate diesel and other such light oil fuels, including but not limited to turbine-style, gear, rotary vane, or roller vane pumps as manufactured by Robert Bosch LLC in Farmington Hills, Mich., or proprietary positive displacement pumps configured to accommodate liquid-gaseous fuel mixtures as manufactured or licensed by US Airflow in Vista, Calif., which pump technology is the subject of U.S. Pat. No. 7,721,641 issued on May 25, 2010, and numerous co-pending patent applications, including but not limited to PCT App. No. US2005/018142, filed May 23, 2005, and PCT App. No. US2008/012533, filed Nov. 6, 2008, and any national stage cases derived therefrom. In alternative embodiments, one or more such delivery pumps may be multi-stage or may be ganged or placed in series to achieve the necessary throughput and pressurization. Any or all such delivery pumps as well as other circulation pumps, high pressure positive displacement pumps or the like that are employed within the system may be powered and controlled using any appropriate means now known or later developed, including but not limited to a pulse-width modulator (not shown). Back to the fuel enhancement system 20, in the first exemplary embodiment, there is provided a flow sensor 43 in-line between the diesel tank 30 and the circulation loop 50, there being a fuel line 35 connecting the circulation loop delivery pump 34 and the flow sensor 43 and a further fuel line 41 from the flow sensor 43 to the fuel line 51 of the circulation loop 50. Additionally, the propane tank 40 supplies propane through fuel line 37 to a flow control valve 44 that then supplies propane through fuel line 38 to the fuel line 41 carrying the diesel fuel as metered by the flow sensor 43. Preferably the propane tank 40 is regulated to a minimum pressure of at least approximately 10 psi greater than the pressure in the fuel line 41 into which the propane is feeding, in the exemplary embodiment, once more, on the order of 15-20 psi, such that the propane is in-fed at approximately 25-30 psi. The flow control valve 44 is controlled by a microprocessor control 45 or the like, which control 45 may be any such device now known or later developed for electrically controlling valves or other such flow control devices and may act on data received from a variety of inputs including but not limited to the flow sensor 43 of the exemplary embodiment, a throttle sensor, or another such monitoring device in a manner known in the art. Accordingly, those skilled in the art will appreciate that while an exemplary electronic metering control is shown and described in connection with the first exemplary fuel enhancement system 20 of FIG. 1, the invention is not so limited, but may instead involve any such components in a variety of combinations and configurations without departing from its spirit and scope. In the exemplary embodiment, the ratio of fuels within the fuel mixture is more than ninety percent (90%) diesel and less than ten percent (10%) propane by volume at the point of mixing, assuming the mixing pressure is at a nominal 80 psi. Generally, the higher the mix pressure the higher the ratio of gaseous fuel and the higher the efficiency gain, to a point, such that it will be appreciated that higher pressures within the system at or after the point of mixing may be employed without departing from the spirit and scope of the invention. It will be further appreciated by those skilled in the art that while two particular fuel constituents are described as comprising the fuel mixture, namely liquid diesel fuel and gaseous propane, and within a specific proportion range, the invention is not so limited and a variety of other fuels as that term is used herein may be employed in various combinations and proportions in conjunction with a homogenizing fuel enhancement system according to aspects of the present invention without departing from its spirit and scope, as further evidenced by the alternative exemplary embodiments of FIGS. 9-12 discussed below. In whatever proportion the fuel constituents are mixed, it will be appreciated that with that ratio set and dictated by the microprocessor control 45 based on data it receives from the flow sensor 43 in the diesel fuel line and the resulting control it has of the propane delivered to the diesel fuel through the flow control valve 44, there is thus little to no variation in the actual proportion or ratio of the constituents within the fuel mixture, which remains substantially constant in operation. And though the flow control valve could be “always on” and the flow therethrough of propane increased or decreased to remain at the desired proportion relative to the diesel fuel flowing through fuel line 41 as measured and reported by the flow sensor 43, in the preferred embodiment the flow control valve 44 is simply switched “on” and “off” by the microprocessor control 45, with the frequency and duration of the “on” propane “pulses” being again dictated by the flow rate of the diesel fuel so that the resulting fuel mixture is of a substantially constant ratio of diesel to propane and only the total volume of such mixture is turned up and down by the system in response to the demands of the engine; i.e., the demand for diesel fuel as dictated by throttle position controlling the injector pump 95 downstream and thereby having an upstream effect on the flow rate of diesel fuel from the tank 30 as measured by the flow sensor 43. It will be appreciated that, as such, the fundamental operation of the engine's fuel delivery system is unaffected by the addition of the homogenizing fuel enhancement system 20 of the present invention, which operates essentially outside and independent of the factory equipment. While a particular group of electronic control devices operably connected in a particular configuration as shown and described in connection with FIG. 1 and metering and delivering to the circulation loop 50 of the fuel enhancement system 20 a substantially fixed-ratio liquid-gaseous fuel mixture, those skilled in the art will appreciate that a number of other such control devices may be employed in various combinations to effectively meter and control the mixing of two or more fuel components without departing from the spirit and scope of the present invention.

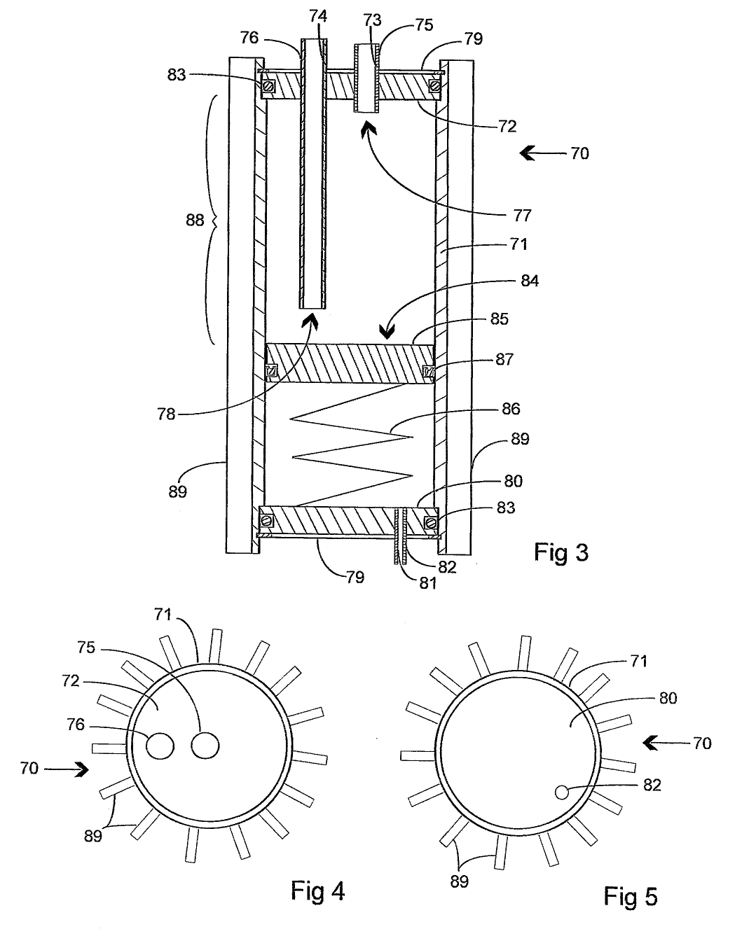

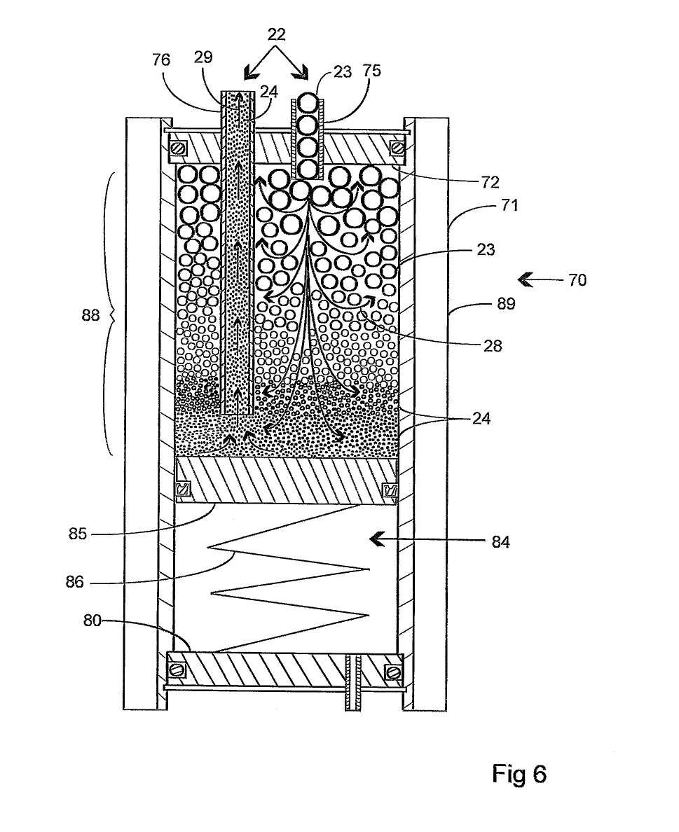

With continued reference to FIG. 1, the exemplary diesel-propane fuel mixture is passed through fuel line 41 to the circulation loop 50, specifically, where the fuel line 41 tees into a fuel line 51 returning excess fuel from the injection pump 95 for recirculation. Fuel line 51 is in fluid communication with the inlet leg 61 of an optional heat exchanger 60 having one or more switchback legs 62 before passing through an outlet leg 63 of the heat exchanger 60 and into a further fuel line 52 of the circulation loop 50. In the exemplary embodiment wherein the circulation loop 50 includes such a heat exchanger 60, it will be appreciated that the additional flow passages and the resulting increased surface area has a cooling effect on the fuel mixture as it passes therethrough. In the present invention, this is desirable not only in that generally to maintain lower fuel temperatures relative to the vehicle's under hood temperature is known to contribute to a more stable and more complete downstream combustion (i.e., reducing inlet fuel temperature has a correlated effect on reduced combustion temperature) and thus to reduced emissions and engine wear. Reduced fuel temperature within the circulation loop 50 is further desirable in the specific context of the present invention as it relates to the infusion tube 70 immediately downstream of the heat exchanger 60 in the exemplary embodiments of FIGS. 1 and 2, in which the fuel mixture is slowed and, based on the fluid flow dynamics within the volumetric expansion of the infusion tube 70, more about which is said below in connection with FIG. 6, the fuel mixture, and particularly the gaseous component thereof, here the propane, further cools and infuses within the liquid fuel component, here the diesel, thereby resulting in a substantially homogeneous fuel mixture passing through the remainder of the circulation loop 50 and made available to the engine's common rail 90. Furthermore, cooling such a diesel-propane fuel mixture as employed in the exemplary embodiment effectively reduces vapor formation within the system, thereby helping prevent vapor lock. Thus, it will be appreciated that generally a heat exchange device of some kind installed within the circulation loop 50 to cool the fuel mixture as it circulates has advantages in use, particularly in the context of the novel infusion tube 70 also included in the circulation loop 50 of the present invention. As such, it will be further appreciated that while a radiator-style heat exchanger 60 is shown and described in connection with the exemplary embodiments of FIGS. 1 and 2, the invention is not so limited, but instead may include any heat exchange device now known or later developed, if any, without departing from the spirit and scope of the invention, including but not limited to optional heat exchange fins 89 (FIGS. 3-6) formed on the infusion tube 70 instead of or in addition to any other heat exchange or cooling devices within the fuel enhancement system 20. As mentioned briefly above, immediately downstream of the heat exchanger 60 is the infusion tube 70, with fuel line 52 as part of the overall circulation loop 50 interconnecting the outlet leg 63 of the heat exchanger with the inlet tube 75 (FIGS. 3-6) of the infusion tube 70. The fuel mixture then passes through the infusion tube 70 and out the outlet down-tube 76 (FIGS. 3-6) as described separately in much greater detail below. In sum, it is in the infusion tube 70, which is a specifically configured volumetric expansion within the circulation loop 50, that the liquid-gaseous fuel mixture becomes substantially homogeneous as the gaseous fuel component is effectively infused within or dispersed throughout the liquid fuel component as caused at least in part by the geometry of the infusion tube 50 and the resulting fluid dynamic effects on the fuel mixture. The substantially homogeneous and relatively cool fuel mixture exiting the infusion tube 50 through the outlet tube 76 (FIGS. 3-6) then passes through fuel line 53 to the fuel filter 99. From the fuel filter 99, the fuel mixture next passes through the only outlet fuel line 92 to a circulation pump 93 that takes the fuel mixture up to a nominal pressure of approximately 60 psi before it passes along fuel line 94 to the engine's injection pump 95 that in the exemplary common rail diesel engine configuration takes the fuel mixture up to a working pressure on the order of 25,000 psi. The fuel mixture needed by the engine is delivered from the injection pump 95 along fuel line 96 to the common rail 90, while unneeded fuel, or fuel beyond the engine's present demand, recycles through the circulation loop along fuel line 51 also in fluid communication with the injection pump 95, and so the cycle continues back through the heat exchanger 60 and infusion tube 70 as above-described, with additional fuel mixture entering the circulation loop 50 as needed and joining the recycled fuel just before the heat exchanger 60. It will be appreciated by those skilled in the art that the circulation pump 93 and the injection pump 95 may be of any type now known or later developed for the purpose of delivering and pressurizing the fuel mixture, here, the two being factory-installed equipment. As factory-installed and configured, both the circulation pump 93 and the injection pump 95 run continuously when the engine is running. It is then important to note for these purposes that the homogenizing fuel enhancement system 20 of the present invention and the operation of the infusion tube 70 as described above and further below in more detail serves to effectively mix and infuse the gaseous fuel component within the liquid fuel component, such that the resulting circulated, substantially homogeneous mixture is effectively seen by the rest of the system, and the delivery and injection pumps, specifically, as a liquid. It will be further appreciated that the circulation loop 50 as thus shown and described herein is a dynamic system that continuously mixes and circulates the fuel mixture, whereby there is no static operation, holding tanks, dead spaces, or the like as in prior art circulation systems. In addition, by effectively existing and operating outside of the engine's injection system, the circulation loop 50 is once again capable of not only continuous and dynamic circulation, but thereby also maintaining the substantially homogeneous fixed ratio of liquid and gaseous fuel components in a low-pressure management context versus the high-pressure context of the common rail 90. As is standard on many common rail diesel engines and other such engines, unused or blow-by fuel from both the common rail 90 and the individual injectors 91 is fed back into the fuel filter 99 along spill-port fuel lines 97 and 98, respectively, for further recirculation and use. Similarly, a further novel feature of the present invention as it relates to the infusion tube 70 is the inclusion therein of an accumulator mechanism 84 (FIG. 3), which includes a blow-by outlet 82 (FIG. 3) in its base for passing fuel that has seeped by the accumulator mechanism 84 out of the infusion tube 70 and through a blow-by return line 68, in the exemplary embodiment, teeing back into the fuel line 33 between the lift pump 32 and the circulation loop delivery pump 34 for further processing. Finally, the exemplary embodiment of FIG. 1 also includes a bypass fuel line 65 teeing from the fuel line 35 between the circulation loop delivery pump 34 and the flow meter 43 and connecting directly to the filter 99, thereby bypassing the flow meter 43 and fuel additive source 40 and the entire circulation loop 50 and thus enabling the provision of pure diesel directly to the engine's common rail 90 if there were to be a problem in another portion of the fuel enhancement system 20. Controlling the operative flow of diesel through the bypass fuel line 65 is an in-line pressure switch or check valve 66 that only opens if the pressure on the downstream side of the valve 66 (i.e., the pressure in the fuel filter 99 or the fuel line 92 running to the circulation pump 93, injection pump 95, and ultimately the common rail 90, drops to a point below the pressure in the bypass fuel line as dictated by the circulation loop delivery pump 34, here on the order of 15-20 psi, which would indicate that the engine is not getting sufficient fuel for some reason. Those skilled in the art will appreciate that in this way the homogenizing fuel enhancement system 20 of the present invention has a fail-safe mode of operation wherein if there is any downstream failure of any component within the circulation loop 50, there is a clog somewhere in the related lines, or there is simply no more fuel additive (i.e., the propane tank 40 is empty or low on pressure), the system 20 will simply revert to running on only diesel fuel, such that the engine or vehicle will continue in an uninterrupted or seamless operation as it transitions back to its original “diesel only” fuel system, with the only downside being the factory fuel mileage rather than the enhanced mileage achieved through implementation of the present invention. This effect is again appreciated in view of the fact that the fuel enhancement system 20 of the present invention operates essentially outside and independent of the factory fuel system equipment, which easily and conveniently lends itself to such a “fail-safe” fuel bypass. It will be further appreciated that while a particular arrangement of the fuel system components and their connectivity through a number of fuel line segments is shown and described in connection with the exemplary embodiment of FIG. 1, the present invention is not so limited. Rather, such components and the means by which they are connected and rendered inter-operable may take a variety of configurations without departing from the spirit and scope of the invention. Again, since FIG. 1 is a schematic view of one fuel system embodiment according to aspects of the present invention, the relative sizes and shapes of the various components are not to be taken strictly, but instead are to be understood as being merely illustrative of the principles and features of the homogenizing fuel enhancement system of the present invention. Accordingly, the substitution of various alternative components serving substantially the same function as those shown and described is possible in the present invention and is expressly to come within its scope.

Turning briefly to FIG. 2, there is shown an alternative embodiment of the fuel system 20 of the present invention much like that of FIG. 1 configured for use in conjunction with a common rail diesel engine, where here there is a mechanical rather than electronic control of the metering and delivery of the fuel components to the circulation loop 50. Specifically, rather than a microprocessor control 45 operably connected to a flow sensor 43 in the diesel fuel line and a flow control valve 44 in the propane fuel line (FIG. 1), instead a metering pump 36 is employed in mechanically metering the fuel components for subsequent mixing. Here, the circulation loop delivery pump 34 passes the diesel fuel from the tank 30 to the metering pump 36 by way of fuel line 35. Separately, the propane gaseous fuel as supplied by pressurized tank 40 passes to the metering pump 36 via fuel line 37 at an approximate regulated pressure to be fixed within the range of 30-80 psi. The metering pump serves to mechanically meter and mix the diesel and propane using any such pump technology now known or later developed, potentially involving multiple discrete pumps or piston units that are slaved to a common drive so as to again effectively mechanically meter the respective fuel constituents passing therethrough. That is, in this alternative exemplary embodiment, the geometry and mechanical operation of the metering pump 36 will set or fix the volumetric ratio of the diesel relative to the propane in a manner generally known in the art, with the metering pump 36 then being turned up or down or simply “on” or “off” based on the demands of the engine, as described more fully below, again, without any variation in the actual proportion or ratio of the constituents within the fuel mixture, which remains substantially constant. Those skilled in the art will appreciate that the operation of the metering pump 36 as it relates to the total volume of fuel mixture delivered to the circulation loop 50 may be tied to one of a number of control or measurement devices now known or later developed, such as a downstream mechanical pressure switch, a flow meter, a throttle sensor, or a microprocessor electronic control (the latter example effectively being a combined electro-mechanical control system). In the case of a mechanical switch, it will be appreciated that such could be operable within the metering pump 36 itself, within the infusion tube 70 as triggered by the position of the accumulator piston 85, as by one or more pressure, position or proximity switches, more about which will be said below in connection with FIG. 3, or simply within a fuel line downstream of the metering pump 36 as shown. Specifically, in the exemplary embodiment, a first fuel line 38 coming out of the metering pump 36 is for metered delivery of the diesel fuel, while a separate second fuel line 39 also coming out of the metering pump 36 carries the propane or other gaseous fuel component, also mechanically metered and not yet mixed with the diesel. In this embodiment, preferably a pressure switch 42 is then placed at some location within the first fuel line 38 carrying the liquid diesel fuel before the mixing point where the first fuel line 38 joins the second fuel line 39, which will enable more accurate and consistent feedback of the actual fuel system demands than by monitoring pressure in the gaseous fuel line or in a downstream fuel line in which a liquid-gaseous fuel mixture is being circulated. Once again, those skilled in the art will appreciate that while a number of variations for mechanical metering, sensing, and control of the fuel mixture and delivery processes have been shown and described, the invention is not so limited but may instead involve a variety of other such components now known or later developed in providing the operable effects. In any case, the exemplary diesel-propane fuel mixture is passed from the metering pump 36 and the first and second fuel lines 38, 39 through single fuel line 41 to the circulation loop 50 for further processing as described above in connection with FIG. 1. A heat exchanger 60 is again shown in-line within the circulation loop 50 between the inlet point for additional fuel mixture as supplied by fuel line 41 and the downstream infusion tube 70, though once more it will be appreciated that other such cooling devices alone or in combination may be employed in the homogenizing fuel enhancement system 20 of the present invention.

Referring now to FIGS. 3-6, there are shown various enlarged schematic views of the infusion tube 70 of FIGS. 1 and 2 so as to better illustrate its structure and function. It will be appreciated that, as schematics, FIGS. 3-6 are not necessarily drawn to scale and so are not to be taken as exact representations particularly as to how the infusion tube would be dimensioned or proportioned (e.g., length, width, wall thicknesses, etc.). Rather, these schematics, again, are representative of the overall structure and principles of operation of the novel infusion tube 70 that is part of the fuel enhancement system 20 of the present invention, and particularly the circulation loop 50.

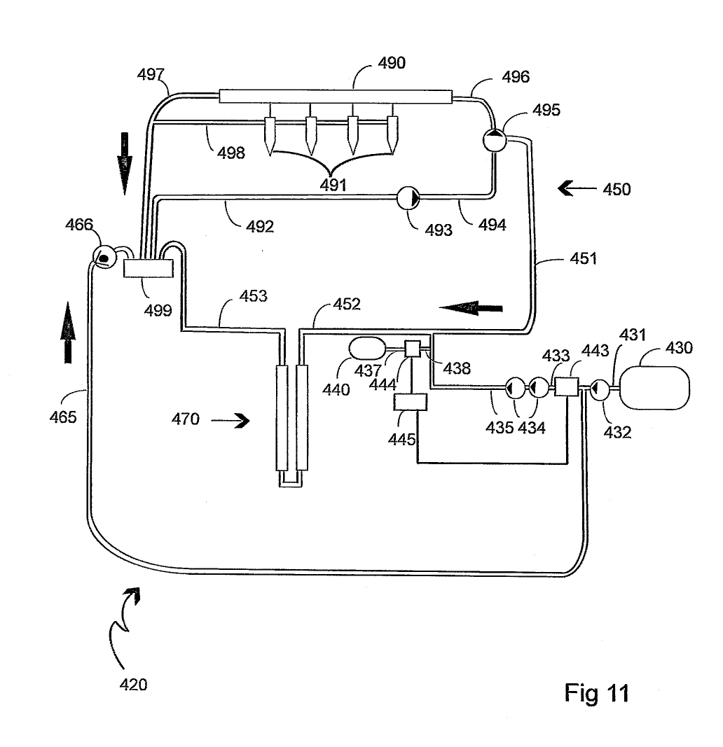

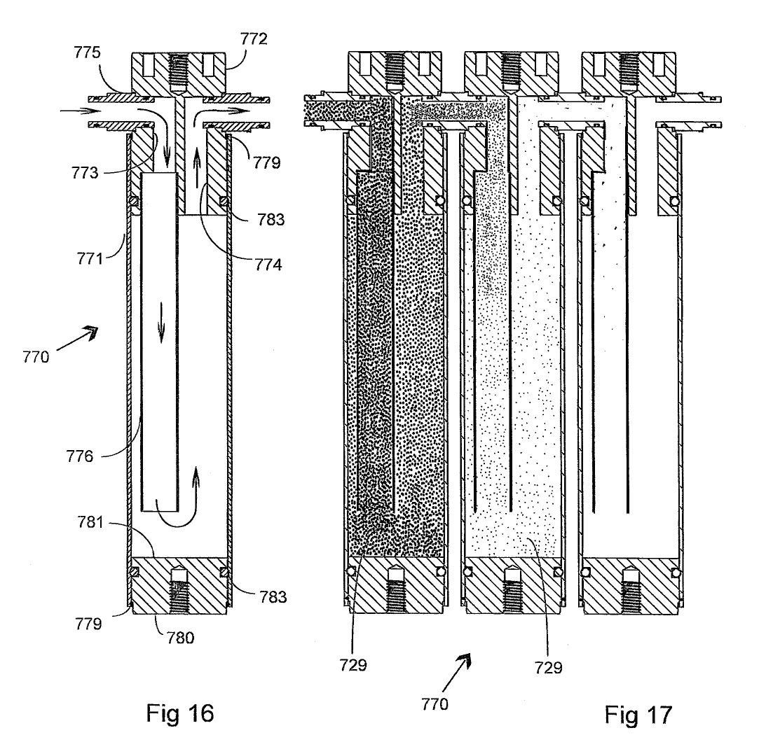

First, in FIG. 3 there is shown an enlarged schematic cross-sectional view of the infusion tube 70. It can be seen that in the exemplary embodiment the infusion tube 70 generally comprises an annular tube wall 71 capped at each end by an annular upper wall 72 and an annular lower wall 80, each sealed within the tube wall 71 by at least one seated o-ring 83 in a manner known in the art. One or both of the upper and lower walls 72, 80 may be integral with the tube wall 71 or may be permanently or removably installed within the tube wall 71 so as to form the infusion tube 70 using any assembly technique now known or later developed, including but not limited to press or interference fit, threaded engagement, bonding, welding, retaining rings or other mechanical couplings or retainers, etc. In the exemplary embodiment, retaining rings 79 are configured to engage respective grooves (not shown) formed in the tube wall 71 so as to trap each end wall 72, 80 against a stepped shoulder formed in each end of the tube wall 71, thus temporarily securing the end walls 72, 80 in a secure and sealed manner while still allowing for relatively easy removal of one or both walls 72, 80 for repair or inspection of the inner components of the infusion tube 70. For example, an accumulator mechanism generally designated 84 is in the exemplary embodiment installed in the lower end of the infusion tube 70 adjacent the lower wall 80, the accumulator mechanism 84 comprising a piston 85 slidably installed within the infusion tube 70 and biased upwardly, or toward the upper wall 72, by a spring 86 installed between the piston 85 and the lower wall 80. A resilient seal or piston ring 87 is seated within the piston 85 to slidingly and sealingly engage the tube wall 71. The piston ring 87 can take any appropriate shape and be formed of any suitable materials now known or later developed, including but not limited to a Buna-N o-ring, lip seal, or u-cup piston seal. As such, the accumulator mechanism 84, and the piston 85 particularly, defines an upper space or infusion volume 88 within the infusion tube 70 above the piston 85 between the piston 85 and the upper wall 72, bounded laterally by a portion of the tube wall 71. It will be appreciated that the infusion volume 88 will fluctuate depending on the pressure in the circulation loop 50 generally and in the infusion tube 70 specifically, with the spring 86 taking up those variances and serving to apply through the accumulator piston 85 the appropriate pressure on whatever fuel mixture is in the upper volume 88 at any given time, more about which will be said below particularly in connection with FIG. 6. It will be appreciated that a separate commercially available bladder-style accumulator, for example, may be substituted for the accumulator mechanism 84 without departing from the spirit and scope of the present invention. In the exemplary piston-style accumulator 84, in connection with measurement of pressure or other such system data for the purpose of feedback and control of the metering and delivery process for the fuel mixture, and by way of further example, a magnetic material may be employed within at least a portion of the piston 85 and at least one corresponding position or proximity switch as is known in the art may be configured within the tube wall 71 of the infusion tube 70, such that relative vertical movement of the piston 85 within the infusion tube 70 as an indicator of circulation loop pressure and hence fuel demand by the engine can be ascertained and communicated to a control device such as a microprocessor 45 (FIG. 1) or metering pump 36 (FIG. 2). With continued reference to FIG. 3, in the exemplary embodiment, two holes or first and second upper passages 73, 74 are formed in the upper wall 72 to serve as inlet and outlet, respectively, of the infusion tube 70 for the fuel traveling through the circulation loop 50, though it will be appreciated that in alternative embodiments there may be more than two total passages and one or more of the inlets or outlets may be positioned in the tube wall 71 rather than the upper wall 72, for example, as shown schematically in FIGS. 1, 2 and 7-10, such that the exemplary structure is to be appreciated as being merely illustrative. As a further aspect of the inlet and outlet of the infusion tube 70 in the exemplary embodiment, a relatively shorter inlet tube 75 is shown as being installed within the first upper passage 73 and a relatively longer outlet down-tube 76 is shown as being installed within the second upper passage 74, once again, more about which will be said below. In sum, though, the fluid flow path into and out of the infusion volume 88 of the infusion tube 70 then involves in the exemplary embodiment flow through the inlet tube 75 and down through the infusion volume 88 against the slight pressure resistance of the accumulator mechanism 84 until reaching the outlet tube bottom or interior end 78 so as to travel up the outlet tube 76 and back into the circulation loop 50. As will be more fully appreciated from the below discussion in connection with FIG. 6, this flow path as dictated, in part, by the longer outlet tube 76 relative to the inlet tube 75, and hence the spatial position of the inlet tube bottom end 77 above the outlet tube bottom end 78, creates a dynamic flow effect within the volumetric expansion or infusion volume 88 of the infusion tube 70 that causes an infusion or substantially homogeneous mixing of the liquid-gas fuel mixture without necessarily requiring circulation loop pressures sufficient in and of themselves to liquefy any gaseous fuel component in the fuel mixture, which it will be appreciated has tremendous advantages in practice. In an exemplary embodiment, the infusion tube 70 is configured with a tube wall 71 made of steel or extruded aluminum tubing having a nominal outside diameter of two inches (2″) and nominal inside diameter of one and seven eighths inch (1⅞″) and an overall length of approximately twenty-one inches (21″). Alternatively, the tube wall 71 may also be formed of an outer aluminum extrusion with an inner steel sleeve for wear resistance or other reasons, in such an embodiment the inner sleeve may be shorter than the outer aluminum extrusion by the appropriate amount such that the sleeve itself forms the upper and lower shoulders against which the upper and lower walls 72, 80 may seat. The upper and lower walls 72, 80 are formed of an aluminum or steel disk having an outside diameter slightly larger than the inside diameter of the tube wall 71 so as to seat on the upper and lower shoulders as described. The thickness of the upper wall 72 is roughly two and half inches (2½″) and the thickness of the lower wall 80 is roughly one and half inch (1½″). The piston 85 of the accumulator mechanism 84 is also a steel or aluminum disk having an outside diameter roughly equivalent to the inside diameter of the tube wall 71 and a thickness of roughly one and half inch (1½″). The spring 86 is a nominal one inch (1″) coil spring having an at rest length of roughly four inches (4″). The spring 86 may be held in place substantially centered on the piston 85 and/or lower wall 80 by a center stud (not shown). The piston ring 87 positioned on the piston 85 is a nominal three eighths (⅜″) thick u-cup piston seal made of Buna-N. Based on the foregoing illustrative dimensions, it will be appreciated that the nominal or at-rest length of the space defining the infusion volume 88 within the infusion tube 70 is about eleven and half inches (11½″). Extending into this volume lengthwise is the outlet tube 76 having a nominal length from the base of the upper wall 72 of about eleven inches (11″), such that there is approximately a half inch (½″) clearance between the lower end 78 of the outlet tube 76 and the accumulator piston 85. The outlet down-tube 72 is a nominal half inch (½″) outside diameter (O.D.) and seven sixteenths inch ( 7/16″) inside diameter (I.D.) steel tube. It follows that the approximate nominal or at-rest infusion volume 88 of the exemplary infusion tube 70 is thirty two cubic inches (32 in³) (Volume=Length×Area=11.5 in.×(Π×(0.94 in.)²)) (not accounting for the movement of the piston 85 or the relatively negligible volume taken up by the outlet tube 76 itself (i.e., its wall) of roughly two cubic inches (2 in³)). Comparing the flow volume within the outlet tube 76 to that of the rest of the infusion tube 70 surrounding the outlet tube 76, it will be appreciated that as those two volumes are more equivalent, a substantially equal rate or velocity of flow into and out of the infusion tube 70 may be established, while as the volume of the outlet down-tube 76 becomes smaller relative to the whole, the fuel mixture will have a tendency to speed up as it exits, more about which is said below in connection with particularly the alternative “reverse flow” infusion tube 770 of FIG. 16. Referring still to FIG. 3 and the construction and operation of the first exemplary infusion tube 70, feeding into the infusion volume 88 is the fuel mixture through a nominal half inch (½″) I.D. high-pressure hose. The fuel mixture exiting the fuel line 52 (FIGS. 1 and 2) into the infusion tube 70, and the infusion volume 88, specifically, via the inlet tube 75 thus goes through an expansion from a roughly half inch (½″) I.D. fuel line to a roughly two inch (2″) I.D. infusion tube 70. This expansion and the subsequent length over which the fuel mixture then travels downwardly through the infusion volume 88 before exiting through the outlet tube 76 has the effect of slowing and infusing the fuel mixture, as explained in even more detail below in connection with FIG. 6, though without over-restricting the flow so as to cause a system back-pressure and additional work on, and resulting losses from, the circulation pump; rather, maintaining a sufficient circulation loop flow rate through the system, including the one or more infusion tubes 70, can both reduce overall power draw and also help avoid gas pocket formation. Those skilled in the art will appreciate that the aspects and principles of the fuel enhancement system 20 of the present invention as it relates to the infusion tube 70 particularly are not in any way limited to the specific exemplary geometry and construction shown and described, which is to be understood as being merely illustrative, but instead may take a number of other configurations without departing from the spirit and scope of the invention, which will be further appreciated from the below discussion related to alternative infusion tube configurations in connection with FIG. 11 and following. Relatedly, as another way of expressing the geometry of the exemplary infusion tube 70, it will be appreciated that the length-to-diameter ratio of the infusion volume 88 is on the order of five to one (5:1) (approximately a ten inch length versus approximately a two inch diameter). While again a variety of other configurations can be employed in the present invention, preferably the length-to-diameter ratio will remain in this five to one (5:1) order of magnitude range to get the desired effects, with the infusion tube 70 then being simply scaled up or down depending on the application (total fuel mixture through-put expected). In any case, the length-to-diameter ratio “order of magnitude range” in the exemplary embodiment would be from about two to one (2:1) up to about thirty to one (30:1), with again on the order of five to one (5:1) being preferable in the exemplary fuel enhancement system 20.

Briefly turning to FIGS. 4 and 5, there are shown schematic top and bottom views, respectively, of the infusion tube 70. In FIG. 4, viewing the infusion tube 70 from the top it can be seen that the inlet tube 75 is in the exemplary embodiment substantially centered in the upper wall 72 with the outlet down-tube 76 then being substantially parallel to and offset from the inlet tube 75. The fluid flow effects of this particular positioning of the inlet and outlet tubes 75, 76 will once again be best understood with reference to FIG. 6, discussed further below. The bottom view of FIG. 5 taken in conjunction with FIG. 3 shows a blow-by outlet 82 installed in a radially offset location in the bottom wall 80 of the infusion tube 70, though it will be appreciated that the exact location of the blow-by outlet 82 is in many ways arbitrary, so long as it does not interfere with the operation of the biasing spring 86 of the accumulator mechanism 84. It will be further appreciated as explained above in connection with FIG. 1 that the purpose of the blow-by outlet 82 is to allow any fuel mixture that has seeped by the piston 85, and the piston ring 87 specifically, to be collected and returned to the circulation loop 50, in the exemplary embodiment of FIGS. 1 and 2 by way of return line 68 and the inlet side of the circulation loop delivery pump 34. In connection with the fuel mixture passing by the piston 85 of the accumulator mechanism 84, those skilled in the art will also appreciate that such a fuel mixture including a light oil fuel like diesel will have a lubricating effect for the moving parts of the infusion tube 70, namely the piston 85 as it travels up and down within the tube 70 as bounded by the tube wall 71.

Referring now to FIG. 6, there is shown a schematic cross-sectional view of the infusion tube 70 illustrating the flow and fluid dynamics of the fuel mixture as it moves through the infusion tube 70 as part of the circulation loop 50 (FIGS. 1 and 2). As the fuel mixture generally designated 22 enters the infusion volume 88 of the infusion tube 70 through the inlet tube 75, the mixture 22 is in the exemplary embodiment a liquid-gaseous mixture, namely diesel plus propane, at a nominal pressure on the order of 20 psi, thus well below the pressure at which propane undergoes a phase transformation from gas to liquid at atmospheric temperature (approximately 125 psi). As such, the liquid-gaseous fuel mixture continues to have at least one constituent in the gaseous phase when mixed and circulated and when introduced into the infusion tube 70, specifically. Therefore, as shown schematically in FIG. 6, as the fuel mixture 22 enters the inlet tube 75, it includes relatively large bubbles 23 representative of the gaseous propane. But as the fuel mixture 22 flows downward within the infusion volume 88 as indicated by arrows 28 in FIG. 6 an eddy current effect is caused as the incoming liquid disperses within the liquid already present within the infusion volume 88. In addition, such descending liquid fluid flow resists the tendency of the bubbles 23 to rise, which action causes the bubbles 23 to break apart until by the time the mixture 22 reaches the bottom of the infusion volume 88 and begins to make its way up the outlet down-tube 76 and out of the infusion tube 70, the bubbles as generally designated 24 are now relatively small as being representative of the propane that has been sufficiently dispersed within the diesel fuel to form a substantially homogeneous liquid-gaseous fuel mixture 22 upon exiting the infusion tube 70 as indicated by arrows 29. In a bit more detail, the bubbles 23 representative of the propane or other gaseous fuel within the fuel mixture break apart upon entry into the infusion tube 70 effectively due to the shear forces in the liquid that overcome the surface tension of the bubbles, causing the bubbles to break apart and consequently a reduction in bubble size. The eddy currents in the infusion tube 70 cause the fluid to work against itself, creating a turbulent mixing action. This action is deliberately intensified in the present design by the introduction of the fuel mixture into the top of the infusion tube 70, which provides an environment where the bubbles attempt to rise against the downward flow of the liquid-gas fuel stream. The result is a relatively controlled, repeatable process to divide and decrease the bubble size to the desired level and thoroughly mix the gaseous bubbles into the fuel stream, or disperse them within the liquid component of the fuel mixture, to provide the desirable result of massive atomization upon injection of the liquid fuel from within the fuel itself, instead of trying to influence the fuel from the outside as has been attempted in prior art designs. It will be appreciated by those skilled in the art that the infusion tube 70 thus has a number of beneficial physical effects on the fuel mixture 22 as it passes therethrough, all essentially dictated by the geometry and configuration of the infusion tube 70. Again, as the fuel mixture 22 exits the inlet tube 75 into the infusion volume 88 it undergoes a volumetric expansion that serves to slow down and cool the fuel mixture 22. This alone encourages the infusion process and, specifically, the tendency of the gaseous fuel component to contract. As described above, the downwardly flowing fuel mixture 22 also resists the tendency of the gas bubbles to rise, both by inertial and frictional effects. Once more, this confluence of descending fuel mixture and ascending bubbles tends to cause a replicating, cascading effect that further mixes or agitates the fuel mixture in a controlled turbulent mixing process, thereby minimizing any unnecessary heat or parasitic energy losses while creating a substantially homogeneous liquid-gas fuel mixture. Thus, those skilled in the art will appreciate that the physical, spatial arrangement of the bottom end 77 of the inlet tube 75 above the bottom end 78 of the outlet down-tube 76 in the exemplary embodiment causes the above-described flow path and the resulting mixing effects. It will be appreciated that while the infusion tube 70 is illustrated as being substantially vertical, other orientations alone or in combination with other geometries of the infusion tube 70 and its components, particularly the inlet and outlet tubes 75, 76, are possible so as to maintain the relative positions of the bottom ends 77, 78 and still obtain the resulting fluid flow dynamics explained above. It will be further appreciated by those skilled in the art that the accumulator mechanism 84 cooperates with the other features of the infusion tube 70 to maintain consistent pressure in the fuel mixture 22 as it moves through the infusion volume 88, the accumulator also serving to take up pressure surges and the like felt throughout the circulation loop 50 in a manner known in the art. Thus, by locating the accumulator mechanism 84 within the infusion tube 70 its benefits for the circulation loop 50 and overall fuel enhancement system 20 are still realized while additional functionality in connection with homogeneously mixing the fuel mixture 22 is also achieved, all while eliminating the need for a separate accumulator component somewhere else in the system. Therefore, those skilled in the art will appreciate that the effective combined infusion tube-accumulator structure has advantages within the fuel enhancement system 20 of the present invention on a number of levels.

More generally, it will be appreciated that the volumetric expansion and resulting eddy current and mixing effects provided by the infusion tube enables sufficient or substantially homogeneous mixing of liquid and gaseous fuel components without the expense and complexity of running at higher pressures and/or temperatures to maintain one or more of the fuel components in a supercritical state or otherwise force through pressure the gaseous fuel component into a liquid state before, during and after mixing with the liquid fuel component as is widely taught in the prior art as effectively the only way to sufficiently mix such fuels together into a common stream prior to injection. The present invention involves no modification to the injection system or the injectors, specifically, as explained above, and so is in the exemplary embodiment literally a bolt-on design that does not affect a vehicle's injection system hardware and electronic controls or factory-installed safety or emissions equipment, though it will be appreciated that a fuel enhancement system according to aspects of the present invention may also be employed as a factory installation instead of an after-market add-on, in which case other aspects of the overall fuel delivery and injection system may be modified or streamlined accordingly, which implementation is also within the spirit and scope of the present invention. In any case, once such a liquid-gas fuel mixture is sufficiently mixed according to aspects of the present invention, and specifically once the gaseous fuel component is infused or dispersed within the liquid fuel component as above-described through the operation of the infusion tube 70 and maintained as such a substantially homogeneous mixture through the continuous circulation loop 50 that exists outside of the injection system, upon injection in the conventional manner of the fuel mixture resulting from the fuel enhancement system 20 of the present invention through any number of injectors 91, it will again be appreciated that the gaseous component within the fuel mixture will have an atomizing effect on the liquid fuel component. That is, upon injection, the fuel mixture will undergo an immediate pressure drop from, in the case of a common rail engine, on the order of 25,000 psi to roughly 300 psi within the combustion chamber. This results in a rather violent expansion of the gaseous fuel component, and because it is substantially homogeneously mixed or dispersed within the fuel mixture, the gaseous fuel component then atomizes the liquid fuel or rapidly scatters the liquid fuel throughout the combustion chamber for a substantially uniform and complete combustion. Again, this effect is achieved in the present invention without the need for maintaining high circulation pressures or supercritical states as is taught in the art. Beyond this physical atomization effect, other chemical or catalytic effects of one fuel component on the other may also be playing a role in the improved performance being seen. The end result is that more power is extracted from the fuel mixture during each combustion event, thereby causing more efficient operation of the engine, with gains on the order of thirty to one hundred percent (30-100%) or more being realized in some cases. In addition, such efficiency gains in no way negatively impact emissions, which is the usual trade-off in prior art approaches, the more complete combustion of the typically hydrocarbon-based liquid fuel resulting in less unburned carbon being exhausted, and since combustion and exhaust gas temperatures are not substantially increased, if at all, other unwanted emissions such as nitrous oxide (NOx) and carbon dioxide (CO₂) are also reduced or at least in the aggregate remain at acceptable levels along with the substantial efficiency gains. And this effect is seen for after-market “bolt on” installations as described herein; even better emissions results without compromising efficiency can be realized when the entire engine is designed around the principles of the present invention.

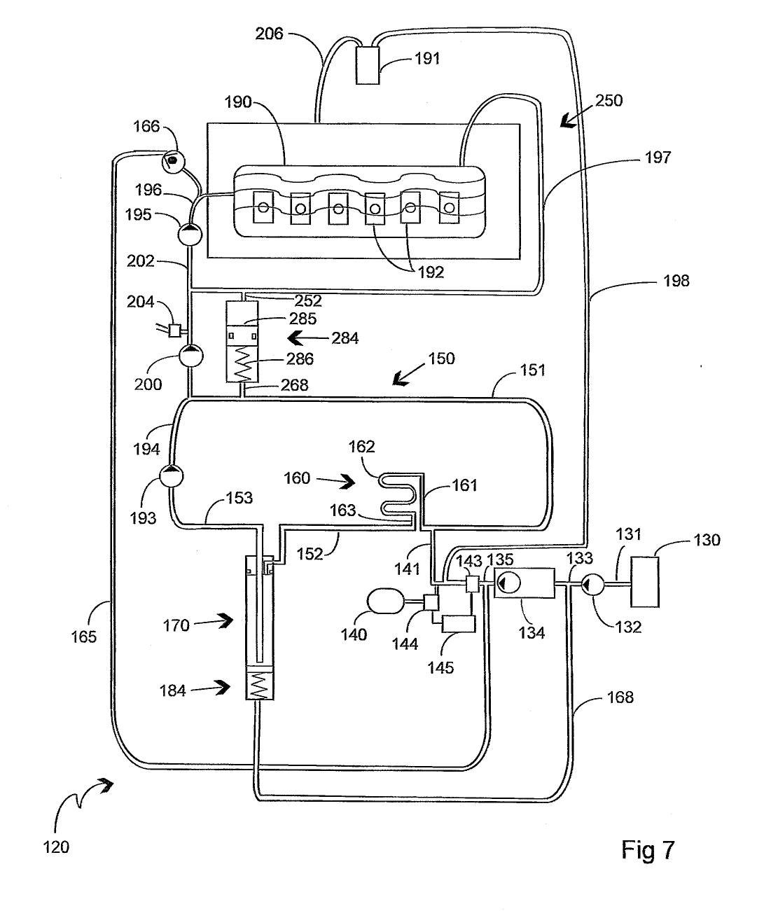

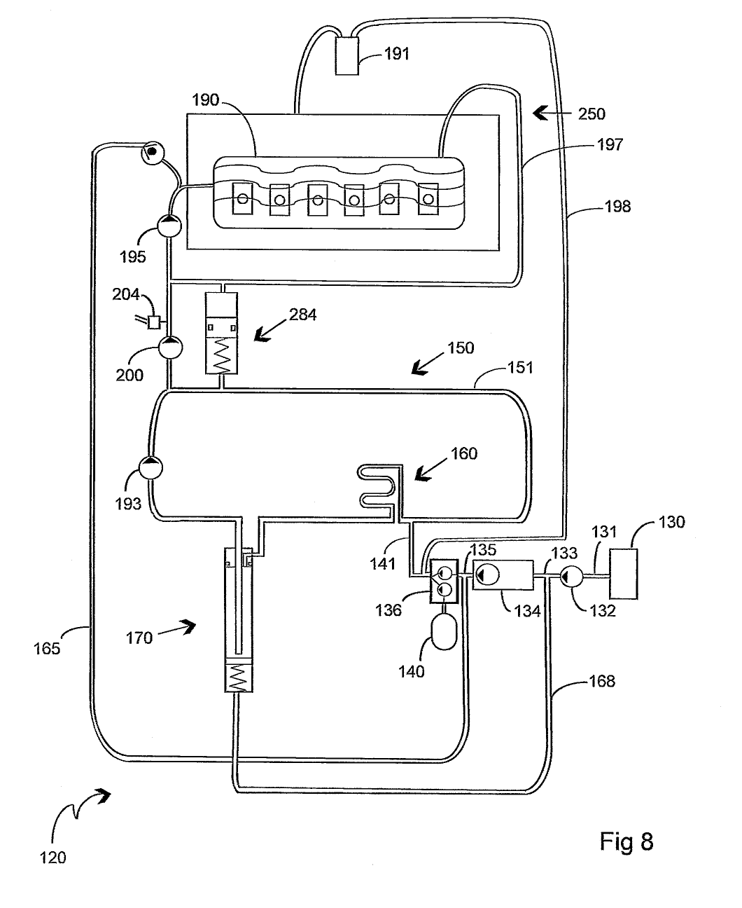

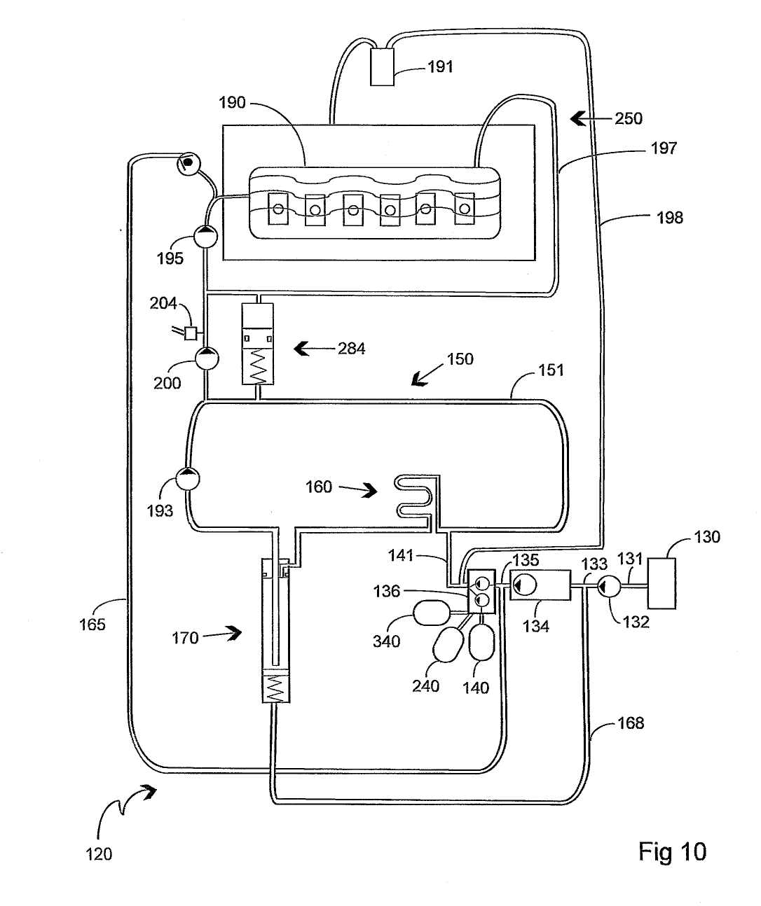

Turning now to FIGS. 7-10, there are shown various alternative embodiments of a fuel enhancement system 120 according to aspects of the present invention as now applied to a mechanical or direct injection diesel engine. In such a context, it will be appreciated that while fuel line or circulation loop pressures may be seen or enabled by factory-installed fuel system equipment that differs from such equipment on a common rail engine, the further embodiments are shown and described merely to illustrate by way of example other ways that the fuel enhancement system 120 of the present invention may be implemented. Accordingly, once more, the present invention is to be understood as not being limited to any one particular embodiment or engine application, but is instead more broadly and generally directed to a homogenizing fuel enhancement system 120 that may be employed in connection with a variety of engines now known or later developed. By way of further overview, it will be appreciated that FIGS. 7 and 9 are directed to alternative multi-fuel embodiments in the direct injection context wherein the fuel components are metered and mixed according to electronic controls and a circulation loop 150 that exists outside of the engine's injection system akin to the first exemplary embodiment of FIG. 1 and that FIGS. 8 and 10 illustrate embodiments wherein the fuel components are metered and mixed mechanically in a manner analogous to the exemplary embodiment of FIG. 2 in the common rail context. FIGS. 7 and 8 in the alternative electrical or mechanical control contexts, respectively, are similar in that, as in the embodiments of FIGS. 1 and 2, a single liquid fuel such as diesel and a single gaseous fuel such as propane are mixed to form the fuel mixture ultimately delivered to the fuel gallery 190, while FIGS. 9 and 10 in the alternative electrical or mechanical control contexts, respectively, are similar in that multiple gaseous fuel components such as propane, hydrogen and air are mixed with a single liquid fuel component, again diesel in the exemplary embodiment. Those skilled in the art will once again appreciate that while particular combinations of liquid and gaseous fuel components are illustrated, the fuel enhancement system 120 of the present invention is not so limited, but instead can effectively be employed in connection with a virtually infinite variety of fuels and fuel mixtures now known or later developed.

Referring now to FIG. 7, there is shown a schematic view of an alternative exemplary embodiment electronic-type control system for a diesel-propane fuel mixture that is to be delivered to a direct injection engine having a fuel gallery 190 with individual plungers 192 to deliver the fuel via line 206 to the individual injectors 191 (one being shown for simplicity) in a manner known in the art. The fuel enhancement system 120 of the present invention includes a flow sensor 143 in-line between the diesel tank 130 and the circulation loop 150, there being a fuel line 135 connecting the circulation loop delivery pump 134 and the flow sensor 143 and a further fuel line 141 from the flow sensor 143 to the fuel line 151 of the circulation loop 150. Additionally, the propane tank 140 supplies propane by way of a flow control valve 144 that then supplies the gaseous propane to the fuel line 141 carrying the diesel fuel as measured by the flow sensor 143. Once more, preferably the propane tank 140 is regulated to a minimum pressure of at least approximately 10 psi greater than the pressure in the fuel line 141 into which the propane is feeding, in the alternative exemplary embodiment, on the order of 40-50 psi based on the diesel tank lift pump 132 taking the pressure to about 10 psi and the engine lift pump or circulation loop delivery pump 134 taking the pressure up approximately another 40 psi—thus, the propane tank 140 in the alternative embodiment is preferably regulated to about 60-100 psi. Again, those skilled in the art will appreciate that the pumps and pressures described above are merely for illustration, with the lift pumps 132, 134 both being factory-installed equipment. The flow control valve 144 is again itself controlled by a microprocessor control 145 or the like, which control 145 may be any such device now known or later developed for electrically controlling valves or other such flow control devices and may act on data received from a variety of inputs including but not limited to the flow sensor 143 of the exemplary embodiment. Accordingly, those skilled in the art will appreciate that while an exemplary electronic metering control is shown and described in connection with the alternative fuel enhancement system 120 of FIG. 7, the invention is not so limited, but may instead involve any such components in a variety of combinations and configurations without departing from its spirit and scope.

With continued reference to FIG. 7, the exemplary diesel-propane fuel mixture is passed through fuel line 141 to the first circulation loop 150, specifically, where the fuel line 141 tees into a fuel line 151 of the first circulation loop 150. Fuel line 151 is in fluid communication with an optional heat exchanger 160 as above-described in connection with FIGS. 1 and 2 and then a further fuel line 152 of the circulation loop 150 that delivers the fuel mixture to an infusion tube 170, again, as described previously, such infusion tube 170 including a built-in accumulator mechanism 184 to cooperate in handling pressure surges within the first circulation loop 150. Here, the fuel mixture leaving the infusion tube 170 travels through fuel line 153 still part of the first circulation loop 150 to a first circulation pump 193 that simply circulates the fuel mixture through the first circulation loop 150, in the exemplary embodiment at a nominal pressure of on the order of 60 psi as dictated by the lift pumps 132, 134 and any back pressure in the system. The fuel mixture leaves the first circulation pump 193 through fuel line 194, which either feeds a high-pressure positive displacement pump 200 that pressurizes the mixture to a pressure on the order of 250-500 psi depending on the context and in turn feeds a second circulation loop 250, and the engine's fuel gallery 190, specifically, based on the demands of the engine. In the exemplary embodiment, a proprietary positive displacement pump 200 configured to accommodate such liquid-gaseous fuel mixtures is employed as manufactured or licensed by US Airflow in Vista, Calif. The “on/off” operation of the positive displacement pump 200 is in the exemplary embodiment controlled by a pressure switch 204 positioned downstream of the pump 200 in fuel line 202, which switch 204 may also be a current limit switch or any other such switch now known or later developed. Unneeded fuel mixture not called for by the positive displacement pump 200 simply tees off of fuel line 194 to fuel line 151 for continual circulation within the first circulation loop 150. Once again, it will be appreciated that the continuous circulation and mixing of the fuel mixture, and particularly its passage through the infusion tube 170, maintains the liquid-gaseous fuel mixture in a substantially homogeneous state even without taking the pressures in the loop 150 higher than the phase change pressure for the gaseous component of the fuel mixture, here propane. And again, the first circulation loop 150 exists completely outside of the engine's injection system, which has a number of advantages as previously described. On the other hand, the fuel mixture that is needed by the engine is delivered from the high-pressure positive displacement pump 200 along fuel line 202 to a second circulation pump 195 that then feeds the fuel gallery 190 via fuel line 196, where it is then ultimately injected by injectors 191 in a manner known in the art. Unused or blow-by fuel from the fuel gallery 190 is returned to the inlet side of the gallery 190 for reuse by passing along spill-port fuel line 197 so as to essentially form a second circulation loop 250, which it will be appreciated is circulating the fuel mixture at pressures on the order of 400 psi as dictated by the high-pressure positive displacement pump 200, while unused or blow-by fuel from the individual injectors 191 is fed back essentially into the first circulation loop 150 along spill-port fuel line 198 for further recirculation and use, line 198 teeing into fuel line 141 downstream of the diesel flow meter 143, whether before or after the propane entry point. A further novel feature of the present invention as it relates to the infusion tube 170 is again the inclusion therein of an accumulator mechanism 184 that includes a blow-by return line 168, in the exemplary embodiment, teeing back into the fuel line 133 between the tank lift pump 132 and the circulation loop delivery pump 134, or factory-installed engine lift pump, for further processing. Similarly, a further novel feature of the present invention is a second accumulator mechanism 284 located effectively between the first and second circulation loops 150, 250 to take out pressure surges in the second circulation loop 250 in a manner generally known in the art. Here, though, specifically, a fuel line 252 teeing into fuel line 197 feeds roughly 400 psi fuel mixture into the upper side of the accumulator, surges in which are absorbed by the piston 285 as biased upwardly by spring 286, with any seepage that gets past the piston 285 passing out of the second accumulator mechanism 284 through fuel line 268 that tees into fuel line 151 of the first circulation loop 150. Thus, it will be appreciated that the pressure differential on both sides of the second accumulator piston 285—roughly 400 psi above and 60 psi below, enables the accumulator to perform as designed while still capturing and reusing any fuel that seeps by the piston 285 during operation. Finally, the exemplary embodiment of FIG. 7 also again includes a bypass fuel line 165 teeing from the fuel line 135 between the circulation loop delivery pump 134 and the flow sensor 143 and connecting directly to fuel line 196 through which fuel is fed by way of the second circulation pump 195 into the fuel gallery 190, thereby bypassing the flow meter 143 and fuel additive source 140 and the entire first circulation loop 150 and thus enabling the provision of pure diesel directly to the engine's fuel gallery 190 if there were to be a problem in another portion of the fuel enhancement system 120. Controlling the operative flow of diesel through the bypass fuel line 165 is an in-line pressure switch or check valve 166 that only opens if the pressure on the downstream side of the valve 166 (i.e., the pressure in fuel line 196 delivering fuel to the fuel gallery 190 drops to a point below the pressure in the bypass fuel line as dictated by the circulation loop delivery pump 134, here on the order of 50-60 psi, which would indicate that the engine is not getting sufficient fuel for some reason. Those skilled in the art will appreciate that in this way the homogenizing fuel enhancement system 120 of the present invention has a fail-safe mode of operation wherein if there is any downstream failure of any component within the circulation loop 150 or other such issue, the system 120 will simply revert to running on only diesel fuel, such that the engine or vehicle will continue uninterrupted operation.

Turning briefly to FIG. 8, there is shown a schematic view of a further alternate embodiment fuel enhancement system 120 wherein a mechanical rather then electrical control is employed in a direct injection context otherwise similar to FIG. 7. Here, as discussed previously in connection with FIG. 2 in the context of the common rail system, the metering pump 136 mechanically meters the diesel and propane fuel in the exemplary embodiment. As a slight variation on the system of FIG. 2, the metering pump 136 as shown in FIG. 8 not only meters but internally mixes the two fuel constituents such that a single fuel line 141 exits the metering pump 136 and delivers such fuel mixture to fuel line 151 of the first circulating loop 150. In such an embodiment, the metering pump 136 may integrally include the appropriate pressure switch or the like in at least the line associated with the liquid fuel constituent for mechanical control of the metering and mixing process as described above.

Referring now to FIGS. 9 and 10, there are shown schematics of still further exemplary embodiments of a fuel enhancement system 120 according to aspects of the present invention wherein multiple gaseous fuel components are introduced or infused into the diesel fuel rather than just one, namely propane, as in the previous exemplary embodiments. First, in the embodiment of FIG. 9 again involving electronic control of the metering process, there is once more shown a diesel tank 130 from which liquid diesel fuel is supplied through the lift pump 132 and delivery pump 134 at an approximate pressure of 50-60 psi to the flow sensor 143. In response to the measured flow of diesel fuel, the microprocessor control 145 in electrical communication with both the flow sensor 143 and here in the alternative embodiment first, second and third flow control valves 144, 244, and 344, respectively, thereby selectively controls the release into the common fuel line 141 gaseous fuel constituents from first, second and third tanks 140, 240 and 340, respectively. Accordingly, appropriate amounts of each of the gaseous fuel components are mixed with the liquid diesel fuel under the control of microprocessor control 145 based on diesel flow data received from the flow sensor 143. As such, it will again be appreciated that the fuel enhancement system 120 of the present invention is capable of proportionately and controllably mixing one or more liquid fuel component with one or more gaseous fuel components, such that once more any number of combinations of such fuels may be mixed and maintained as a substantially homogeneous mixture employing aspects of the present invention. In the exemplary embodiment of FIG. 9, the three tanks 140, 240 and 340 supply propane, hydrogen and air to the diesel fuel to form the liquid-gaseous fuel mixture. It will be appreciated that any such tanks may be replaced with, for example, an electrolysis apparatus (not shown) for the purpose of generating hydrogen gas on board or, in the case of air, simply a filtered inlet open to the environment for the purpose of drawing in ambient air, again, as metered by the flow control valves 244, 344, respectively. Accordingly, while three tanks 140, 240, and 340 are shown in the schematic of FIG. 9, it will be appreciated that the invention is not so limited, but may instead involve a variety of other gaseous fuel component storage and/or generation devices now known or later developed, and in any number, without departing from the spirit and scope of the invention. Turning briefly to FIG. 10, there is shown a schematic of yet another alternative embodiment of the fuel enhancement system 120 of the present invention wherein a mechanical metering pump 136 is employed rather than an electrical control system in metering and mixing liquid diesel propane 130 with gaseous propane, hydrogen, and air from sources 140, 240, and 340. The types of fuels that are mixed to form the liquid-gaseous fuel mixture, the proportions in which and pressures at which they are mixed, and the particular configurations of the one or more circulation loops and infusion tubes may vary without departing from the spirit and scope of the invention, Therefore, those skilled in the art will appreciate that aspects of the present invention may be employed in a number of configurations and contexts beyond the exemplary embodiments shown and described, such that the fuel enhancement system of the present invention is to be understood as not being limited to any particular embodiment shown and described herein.

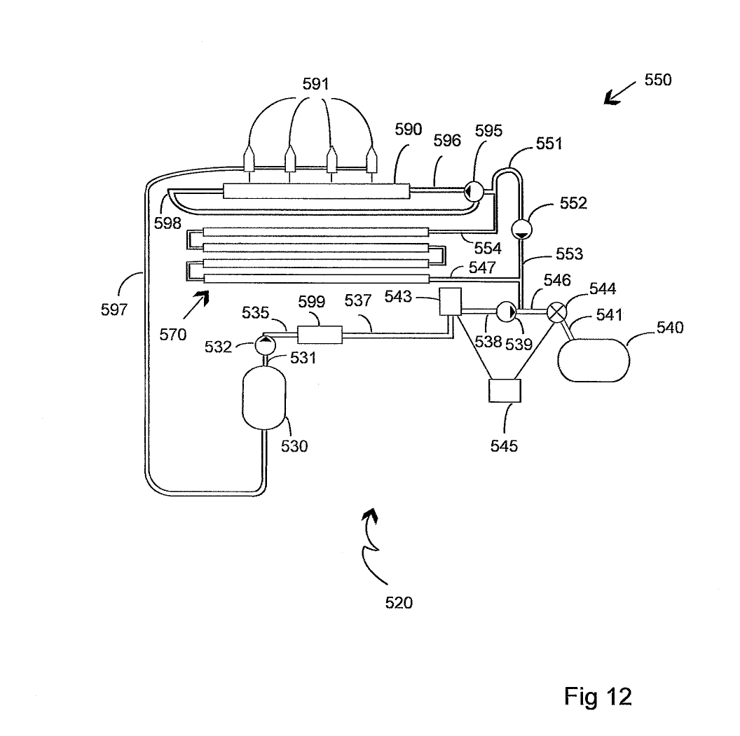

Turning next to FIGS. 11 and 12, by way of further illustration of aspects of the present invention, there are shown further exemplary homogenizing fuel enhancement systems employing two or more infusion tubes of a different variety than those shown and described in connection with FIGS. 1-10 and employing nitrogen as the gaseous fuel component, whether from a pressurized tank or an on-board generation device. As a threshold matter, it is to be understood that the use of a different number and configuration of infusion tubes was not dictated by the use of nitrogen as the gaseous fuel or vice versa. Rather, the incorporation of these two variations on the prior exemplary systems of FIGS. 1-10 in the systems of FIGS. 11 and 12 is merely for illustration of these further aspects. Again, the exemplary system includes a nitrogen source such as a tank or on-board generation device to supply nitrogen gas to be mixed with the diesel fuel prior to direct injection, which through the rest of the system yields a substantially homogeneous diesel-nitrogen fuel mixture that is then injected in the conventional fashion, the nitrogen having an atomization effect on the diesel within the combustion chamber and thereby improving combustion efficiency. As mentioned previously, additional components may be interchangeably incorporated in any such multi-fuel system for added or ancillary functionality, such as one or more liquid or gaseous fuel supply tanks, a flow control system for essentially metering the gaseous fuel into the liquid fuel, whether mechanical or electrical, and, in an “open loop” configuration, a return line to the liquid fuel tank where the gaseous fuel additive can vent or out-gas, more about which is said below.

In the exemplary embodiment of FIG. 11, there is shown an overall fuel system 420 generally including a diesel tank 430 with a lift pump 432 and a pressurized nitrogen tank 440 both feeding into a circulation loop generally designated 450 and including a pair of infusion tubes 470, the circulation loop 450 being in fluid communication with the engine's injection system common rail 490 and injectors 491, here by way of the fuel filter 499. In more detail, the diesel tank 430 supplies diesel fuel through a fuel line 431 by way of the lift pump 432 again at about 5 psi, all of which are factory-installed equipment that could be self-contained within the tank 430 or separately configured as shown for convenience in FIG. 11. The diesel fuel then passes via fuel line 433 to a series of circulation loop delivery pumps 434 that take the diesel fuel up to approximately 60-100 psi in the exemplary embodiment. It will be appreciated that this pressure range can vary significantly depending on the application and engine parameters, such that the stated pressure, and all such pressures throughout, is to be understood as being merely illustrative. Though two delivery pumps 434 are shown in the exemplary embodiment, one pump or three or more may be employed instead without departing from the spirit and scope of the invention, as will be further appreciated in connection with the alternative exemplary embodiment of FIG. 12, discussed below. It will be appreciated that the one or more circulation loop delivery pumps 434 may be any fluid pump now known or later developed and configured for appropriate pressures and power draw and to accommodate diesel and other such light oil fuels, including but not limited to gear-style, rotary vane, or roller vane pumps as manufactured by Robert Bosch LLC in Farmington Hills, Mich., or proprietary positive displacement pumps configured to accommodate liquid-gaseous fuel mixtures as manufactured or licensed by US Airflow in Vista, Calif. In alternative embodiments, one or more such delivery pumps may be multi-stage or may be ganged or placed in series as shown to achieve the necessary throughput and pressurization. Any or all such delivery pumps as well as other circulation pumps, high pressure positive displacement pumps or the like that are employed within the system may be powered and controlled using any appropriate means now known or later developed, including but not limited to a pulse-width modulated drive (not shown). Back to the fuel enhancement system 420, in this exemplary embodiment, there is provided a flow sensor 443 in-line between the diesel tank 430 and the circulation loop 450, whether upstream or downstream of the one more delivery pumps 434, here shown as being upstream of the pumps 434 within fuel line 433. A further fuel line 435 connects the circulation loop delivery pumps 434 to the fuel line 451 of the circulation loop 450. Additionally, the exemplary nitrogen tank 440 supplies nitrogen through fuel line 437 to a flow control valve 444 and then through fuel line 438 to the fuel line 441 carrying the diesel fuel as metered by the flow sensor 443. Preferably the nitrogen tank 440 is regulated to a minimum pressure of at least approximately 10 psi greater than the pressure in the fuel line 441 into which the nitrogen is feeding, in the exemplary embodiment, once more, on the order of 60-100 psi. The flow control valve 444 is controlled by a microprocessor control 445 or the like, which control 445 may be any such device now known or later developed for electrically controlling valves or other such flow control devices and may act on data received from a variety of inputs including but not limited to the flow sensor 443 of the exemplary embodiment, a throttle position sensor, or another such monitoring device in a manner known in the art. Accordingly, those skilled in the art will once again appreciate, as evident from FIGS. 1, 2 and 7-10, that while an exemplary electronic metering control is shown and described in connection with the exemplary multi-fuel system 420 of FIG. 11, the invention is not so limited, but may instead involve any such components in a variety of combinations and configurations without departing from its spirit and scope. In the exemplary embodiment, the ratio of fuels within the fuel mixture is more than ninety percent (90%) diesel and less than ten percent (10%) nitrogen by volume at the point of mixing, assuming the mixing pressure is at a nominal 100 psi. It will be appreciated by those skilled in the art that while two particular fuel constituents are described as comprising the fuel mixture, namely liquid diesel fuel and gaseous nitrogen, and within a specific proportion range, the invention is not so limited and a variety of other fuels as that term is used herein may be employed in various combinations and proportions in conjunction with a homogenizing fuel enhancement system according to aspects of the present invention without departing from its spirit and scope.

With continued reference to FIG. 11, the exemplary diesel-nitrogen fuel mixture is passed through fuel line 435 to the circulation loop 450, specifically, where the fuel line 435 tees into a fuel line 451 returning excess fuel from the injection pump 495 for recirculation. The fuel mixture then passes through a series of infusion tubes 470, two in the exemplary embodiment, the structure and advantages of which are explained both in the prior applications incorporated by reference herein and in connection with the bank of infusion tubes employed in the alternative embodiment of FIG. 12 discussed further below. In sum, it is in the one or more infusion tubes 470, each of which is a specifically configured volumetric expansion within the circulation loop 450, that the liquid-gaseous fuel mixture slows and becomes substantially homogeneous as the gaseous fuel component is effectively infused within or dispersed uniformly throughout the liquid fuel component as caused at least in part by the geometry of the infusion tubes 470 and the resulting fluid dynamic effects on the fuel mixture. The infusion tubes 470 thus have a cooling effect on the fuel as well, which may be further enhanced by placing fins (not shown) on the outer wall of each tube or even separately through a heat exchanger (not shown) incorporated elsewhere in the system. The substantially homogeneous and relatively cool fuel mixture exiting the infusion tubes 470 then passes through fuel line 453 to the fuel filter 499. From the fuel filter 499, the fuel mixture next passes through the only outlet fuel line 492 to a circulation pump 493 that takes the fuel mixture up to a nominal pressure of approximately 150 psi before it passes along fuel line 494 to the engine's injection pump 495 that in the exemplary common rail diesel engine configuration takes the fuel mixture up to a working pressure on the order of 25,000 psi. Once again, it is to be understood that all such pressures are merely illustrative and in no way limit the present invention. The fuel mixture needed by the engine is delivered from the injection pump 495 along high-pressure fuel line 496 to the common rail 490, while excess fuel, or fuel beyond the engine's present demand, recycles through the circulation loop along fuel line 451 also in fluid communication with the injection pump 495, and so the cycle continues back through the infusion tubes 470 as above-described, with additional fuel mixture entering the circulation loop 450 as needed and joining the recycled fuel just before the infusion tubes 470. It will be appreciated by those skilled in the art that the circulation pump 493 and the injection pump 495 may be of any type now known or later developed for the purpose of delivering and pressurizing the fuel mixture. Once again, then, the fuel enhancement system 420 of the present invention and the operation of the one or more infusion tubes 470 as described above and further below in a bit more detail serves to effectively mix and infuse the gaseous fuel component within the liquid fuel component, such that the resulting circulated, substantially homogeneous mixture is effectively seen by the rest of the system, and the delivery and injection pumps, specifically, as a liquid, with the related operation and advantages of the circulation loop again being realized in the further alternate embodiment. Finally, the exemplary embodiment of FIG. 11 also includes a bypass fuel line 465 teeing from the fuel line 433 between the lift pump 432 and the flow meter 443 and connecting directly to the filter 499, thereby bypassing the flow meter 443, the one or more delivery pumps 434, and the fuel additive source 440 and the entire circulation loop 450 and thus providing a “fail-safe.” It will be further appreciated that while a particular arrangement of the fuel system components and their connectivity through a number of fuel line segments is shown and described in connection with the alternate exemplary embodiment of FIG. 11, the present invention is not so limited. Rather, such components and the means by which they are connected and rendered inter-operable may take a variety of configurations without departing from the spirit and scope of the invention. And again, since FIG. 11 is a schematic view of one fuel system embodiment according to aspects of the present invention, the relative sizes and shapes of the various components are not to be taken strictly, but instead are to be understood as being merely illustrative of the principles and features of the multi-fuel system of the present invention. Accordingly, the substitution of various alternative components serving substantially the same function as those shown and described is possible in the present invention and is expressly to come within its scope.

Referring now to FIG. 12, there is shown a schematic of a further exemplary embodiment multi-fuel system 520 according to aspects of the present invention for use again in conjunction with a “common rail” diesel engine. In this illustrated embodiment the injection system includes solenoid- or old-style HEUI (Hydraulic Electronic Unit Injector)-style injectors 591 or any other injectors that are relatively sensitive to pressure, and particularly back pressure, such that the return line 597 is shown as leading back to the tank 530 at near ambient pressure, more about which will be said below. As a threshold matter, it is noted that though this alternative exemplary embodiment of the homogenizing fuel enhancement system is illustrated in the context of such an “open loop” fuel line configuration, the invention is not so limited, but again may be employed in conjunction with a variety of engines, injectors, and attendant fuel line configurations without departing from its spirit and scope, such as the nominally “closed loop” systems in the embodiments of FIGS. 1-11. It is further noted once more that while a number of engine components are shown as part of the figures generally throughout, such as the common rail 590, the fuel filter 599, the primary diesel tank 530 and lift pump 532, and related fuel lines and the like, all such components or any variations thereof or substitutions therefor may be employed, whether factory-installed or after-market, in conjunction with the present invention without departing from its spirit and scope. Thus, while such components are shown in the figures as part of the overall fuel system, it is to be understood that the invention is expressly not limited thereto and that no claim is made to such standard components of an engine, which are provided herein simply as context for the fuel system of the present invention. Moreover, again, while the exemplary embodiments are specifically shown and described in connection with a diesel internal combustion engine, a variety of other engines now known or later developed may be employed, including but not limited to gasoline direct injection engines.

By way of overview, in the alternative exemplary embodiment of FIG. 12, there is shown an overall fuel system 520 generally including a diesel tank 530 with a lift pump 532 and a nitrogen tank 540 both feeding into a series of infusion tubes generally designated 570 that are then in fluid communication with the engine's injection system common rail 590 and injectors 591. In more detail, the diesel tank 530 supplies diesel fuel through a fuel line 531 by way of the lift pump 532 at about 5 psi, all of which are factory-installed equipment that could be self-contained within the tank 530 or separately configured as shown for convenience in FIG. 12. For further liquid fuel supply, additional tanks may be connected in series or parallel to the downstream fuel line 535, which may be automatic or manual as needed. The diesel fuel then passes via fuel line 535 through a fuel filter 599 and then through a fuel line 537 to a flow meter 543, more about which will be said below. From the flow meter 543, the diesel fuel passes through another fuel line 538 to a delivery pump 539 that takes the diesel fuel up to approximately 60-100 psi in the exemplary embodiment. It will again be appreciated that the delivery pump 539 may be any fluid pump now known or later developed and configured for appropriate pressures and power draw and to accommodate diesel and other such light oil fuels. In alternative embodiments, as in FIG. 11, multiple delivery pumps may be employed in a ganged or series arrangement to achieve the necessary throughput and pressurization. Back to the fuel enhancement system 520, in this further alternative exemplary embodiment, there is again provided a flow sensor 543 in-line between the diesel tank 530 and the infusion tubes 570 that is electrically connected to a control 545 for the purpose of monitoring the flow of diesel fuel and regulating the release of nitrogen accordingly. Specifically, the nitrogen tank 540 supplies nitrogen through fuel line 541 to a flow control valve 544 that then supplies nitrogen through fuel line 546 to the diesel fuel delivered by the delivery pump 539 as monitored by the flow sensor 543. Once more, the flow control valve 544 within the nitrogen supply line is controlled by a microprocessor control 545 or the like, which control 545 may be any such device now known or later developed for electrically controlling valves or other such flow control devices and may act on data received from a variety of inputs including but not limited to the flow sensor 543 of the exemplary embodiment. Again, it will be appreciated that while an exemplary electronic metering control is shown and described in connection with the exemplary fuel enhancement system 520 of FIG. 12, the invention is not so limited, but may instead involve any such components in a variety of combinations and configurations without departing from its spirit and scope. In terms of the gaseous fuel supply, preferably the nitrogen tank 540 is regulated to a minimum pressure of at least approximately 10-20 psi greater than the pressure in the fuel line 546 into which the nitrogen is feeding, in the exemplary embodiment, once more, on the order of 60-100 psi as dictated by the one or more delivery pumps 539. It is further contemplated that in place of or in addition to the nitrogen tank 540 there may be provided an on-board nitrogen generation device employing any technology or technique now known or later developed, including but not limited to membrane, VSA and PSA/zeolite technologies. Such a generator may feed nitrogen gas directly to the fuel enhancement system 520, thus as a substitution for tank 540, or may be in series with and upstream of the tank 540 so as to charge the tank 540, from which the nitrogen gas would then be supplied as otherwise described above. Thus, one aspect of the invention can be summarized as producing nitrogen on-board a vehicle for use as a fuel additive that is to be mixed with the liquid fuel pre-direct injection so as to form a multi-fuel system. It will be appreciated that on-board nitrogen generation may also be employed in connection with the embodiment of FIG. 11 or other multi-fuel systems such as those described above in connection with FIGS. 1-10 depending on the context, further exemplary ones of which are shown and described in the prior patent applications incorporated herein by reference.

With continued reference to FIG. 12, the exemplary diesel-nitrogen fuel mixture is passed through fuel line 547 to the infusion tubes 570. Here, there are shown four infusion tubes 570 in series, but once again, any number and size and shape of infusion tubes may be employed without departing from the spirit and scope of the invention. It is in the one or more infusion tubes 570, which are again essentially a volumetric expansion within the fuel line or fuel delivery system, that the liquid-gaseous fuel mixture becomes substantially homogeneous as the gaseous fuel component is effectively infused within or uniformly dispersed throughout the liquid fuel component as caused at least in part by the geometry of the infusion tubes 570 and the resulting fluid dynamic effects on the fuel mixture. The substantially homogeneous fuel mixture exiting the infusion tubes 570 through fuel line 554 next passes to the engine's injection pump 595, which in the exemplary common rail diesel engine configuration takes the fuel mixture up to a working pressure on the order of 25,000 psi. The fuel mixture needed by the engine is delivered from the injection pump 595 along fuel line 596 to the common rail 590, while excess fuel, or fuel beyond the engine's present demand, recycles along fuel line 551 also in fluid communication with the injection pump 595 and itself including a circulation pump 552 connected via fuel line 553 with the initial liquid-gaseous fuel mixture supply line 547, and so the cycle continues back through the infusion tubes 570 as above-described, thereby forming a circulation loop 550 in the present embodiment. It is then noted that the multi-fuel fuel system 520 of the present invention and the operation of the infusion tubes 570 as described above serves to effectively mix and infuse the gaseous fuel component within the liquid fuel component, such that the resulting substantially homogeneous mixture is effectively seen by the rest of the system, and the delivery and injection pumps, specifically, as a liquid. As is standard on many common rail diesel engines and other such engines, unused or blow-by fuel from both the common rail 590 and the individual injectors 591 is part of a feedback system to recapture and reuse such non-combusted fuel. In the exemplary “open loop” system shown in FIG. 12, the unused fuel from the common rail 590 itself is fed back to the injection pump 595 along spill-port fuel line 598, while the non-combusted fuel from the actual injectors 591 is instead returned directly to the tank 530 along spill-port fuel line 597 for further use. Such a configuration is in a sense necessitated where back pressure-sensitive injectors such as in certain old-style common rails are employed in the injection system. Thus, by returning the spill-port line 597 to the tank at roughly ambient pressure, the injectors 591 are not adversely affected. As an added benefit, by using a widely available, and hence relatively inexpensive, and inert gas like nitrogen as the gaseous fuel additive in a multi-fuel system according to aspects of the present invention, it will be appreciated that the nitrogen venting into the tank 530 and thereby at least partially filling the space above the liquid fuel actually provides an anti-detonation safety effect for the vehicle as compared to having air alone or other gas that promotes combustion along with liquid fuel vapors occupying the dead space in the tank. And since nitrogen is so readily available and relatively inexpensive to produce on board, its added function as an inerting agent within the tank 530 comes at a relatively low cost.

It will be further appreciated that while a particular arrangement of the fuel system components and their connectivity through a number of fuel line segments is shown and described in connection with the alternative exemplary embodiment of FIG. 12, the present invention is again not so limited. Rather, such components and the means by which they are connected and rendered inter-operable may take a variety of configurations without departing from the spirit and scope of the invention. Specifically, though not shown in FIG. 12, it will be appreciated that this alternative set up may also include a failsafe bypass line to allow the system to operate “diesel only” as needed, much like that shown in FIGS. 1, 2 and 7-11. Again, since FIG. 12 is a schematic view of one fuel system embodiment according to aspects of the present invention, the relative sizes and shapes of the various components are not to be taken strictly, but instead are to be understood as being merely illustrative of the principles and features of the homogenizing fuel enhancement system of the present invention. Accordingly, the substitution of various alternative components serving substantially the same function as those shown and described is possible in the present invention and is expressly to come within its scope.

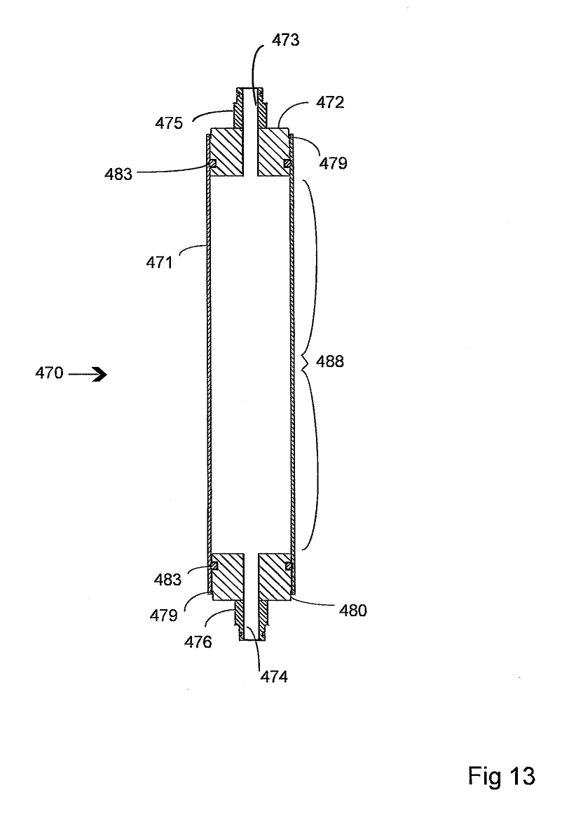

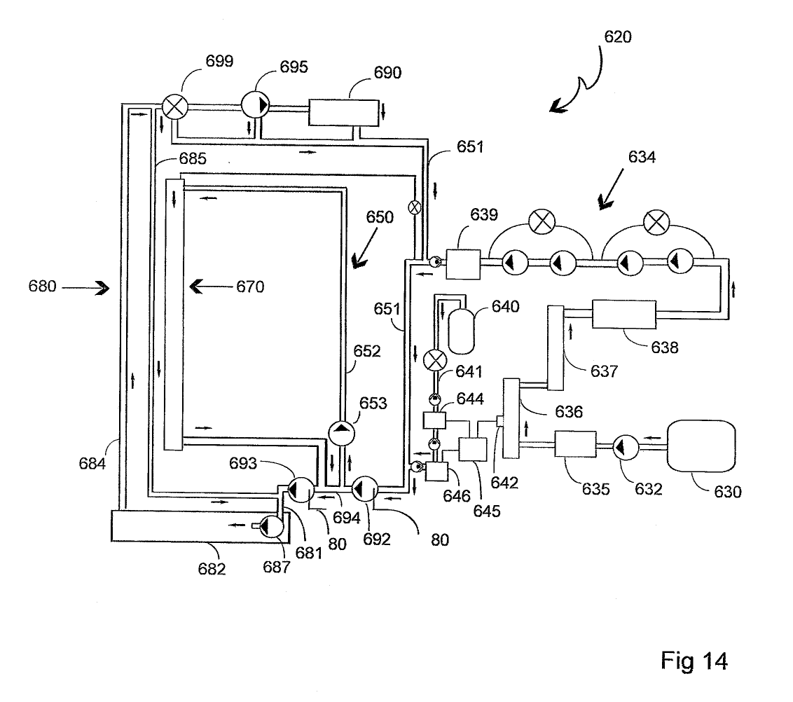

Regarding the infusion tubes 470, 570 shown in FIGS. 11 and 12, and now with reference to FIG. 13, it can be seen that each such infusion tube, generally denoted 470 for simplicity, is of a straight through-flow configuration, not having particularly the down-tube 76 or accumulator 84 as in the prior exemplary embodiment of the infusion tube 70 shown in FIGS. 3-6. That is, as is evident from the system schematics of FIGS. 11 and 12 and now with reference to the cross-sectional schematic view of FIG. 13, the fuel mixture flow path is essentially such that the fuel enters at one end of the infusion tube 470 through a first passage 473 formed in a first connector 475 and a first end wall 472, down through the tube 470 and out through a second passage 474 formed in a second end wall 480 and a second connector 476. To form the complete infusion tube 470, in the exemplary embodiment, once again each end wall 472, 480 is secured in place within the tube wall 471 using an interference fit and o-ring 483 seal with a mechanical retaining ring 479. It will be appreciated that any other functionally equivalent structure now known or later developed may be substituted without departing from the spirit and scope of the invention. Relatedly, the components of the infusion tube 470 can be formed from any suitable material now known or later developed, though it is presently contemplated that they will primarily be made of aluminum. In the exemplary embodiment of the infusion tube 470 shown in FIGS. 11-13, then, an infusion volume 488 is formed based essentially on the inside length and inside diameter of the tube wall 471; that is, the volume bounded by the tube wall 471 and the first and second end walls 472, 480. For illustration, each infusion tube 470 may have a nominal outside diameter of two inches (2″) and nominal inside diameter of one and seven eighths inch (1⅞″) and an overall length of approximately forty-two inches (42″), or approximately twice the length of the exemplary infusion tube 70 of FIGS. 1-10. Moreover, without the accumulator 84 (FIG. 3), even more of the space within the infusion tube 470 is a volumetric expansion region for the fuel mixture; assuming a one inch (1″) thickness of each end wall 472, 480, the total infusion volume 488 within each alternative through-flow infusion tube 470 is one hundred eleven cubic inches (111 in³) (Volume=Length×Area=40 in.×(Π×(0.94 in.)²)). As such, it is noted that the infusion volume 488 of the alternative infusion tube 470 of FIG. 13 is nearly four times that of the first exemplary infusion tube 70 of FIGS. 3-6 having a total infusion volume of approximately thirty-two cubic inches (32 in³). Moreover, while the length-to-diameter ratio of that first exemplary infusion tube 70 was about 5:1, that of the alternative infusion tube 470 is about 20:1. Assuming a nominal half inch (½″) I.D. or larger inlet and outlet size through the respective first and second flow passages 473, 474, the fuel mixture exiting the inlet or first flow passage 473 into the infusion tube 470, and the infusion volume 488, specifically, goes through an expansion from a roughly half inch (½″) fuel line to a roughly two inch (2″) I.D. infusion tube 470. This expansion and the subsequent length over which the fuel mixture then travels through the infusion volume 488 before exiting through the outlet or second flow passage 474 has the effect of greatly slowing and mixing the fuel mixture, as explained above in connection with FIG. 6. Only here, in the alternative embodiment of FIG. 13, the fuel continues on its path through the infusion tube 470 and out the opposite end rather than reversing direction to go up and out the top again through the outlet tube 76 (FIGS. 3-6). It will be appreciated that with such a straight through-flow set-up there is not then the same emphasis on having the inlet above the outlet and attendant relatively vertical orientation to achieve the eddying effects, as enhanced in part by gravity as in the above discussion in connection with FIG. 6 relating to the bubbles attempting to rise against the downwardly flowing fuel; rather, with such a straight through-flow infusion tube 470, the design is more velocity-dependent than orientation-dependent, thus able to perform substantially the same whether horizontal or vertical. It will also be appreciated that where multiple infusion tubes 470, 570 are employed in series, not only is the total infusion volume increased accordingly, totaling approximately two hundred twenty-two cubic inches (222 in³) in the two-infusion tube system 420 of FIG. 11 and about four hundred forty-four cubic inches (444 in³) in the four-infusion tube system 520 of FIG. 12, but the successive expansions and contractions of the fuel mixture further contribute to the homogenizing effects as well. Those skilled in the art will once again appreciate that the aspects and principles of the fuel enhancement systems 420, 520 of the present invention as relating to the infusion tubes 470, 570 particularly are not in any way limited to the specific exemplary geometry and construction shown and described, as should again be appreciated from the above discussion in connection with FIGS. 1-10 and further from the below discussion regarding additional alternative embodiments shown in FIGS. 14-17 and 20-21. More generally, it will be appreciated that the volumetric expansion and resulting eddy current and mixing effects provided by the two or more infusion tubes 470, 570 of FIGS. 11 and 12 enable sufficient or substantially homogeneous mixing of liquid and gaseous fuel components, again without the expense and complexity of running at relatively higher pressures or otherwise to force the gaseous fuel component into a liquid state; rather, by sufficiently mixing and infusing the gaseous fuel within the liquid fuel, the resulting multi-fuel mixture is seen as a liquid by the rest of the system, particularly the injection system, even though the gaseous fuel component remains in that state at least until it is introduced to the injector pump. And in the case of an inert gas such as nitrogen, which the prior art essentially teaches away from as a combustive fuel additive, this atomization effect is still achieved as the dispersed gas affects the fuel from the inside out, even if the gaseous fuel itself, here nitrogen, essentially has no fuel value of its own. But again, what a gaseous fuel even such as nitrogen does have and hence acts as within the liquid fuel is a potential energy spring that is released upon injection and mechanically breaks apart the liquid fuel. Beyond this physical atomization effect, other chemical or catalytic effects of one fuel component on the other may also be playing a role in the improved performance being seen. The end result is that more power is extracted from the fuel mixture or less fuel is unused during each combustion event, thereby causing more efficient operation of the engine, with gains on the order of thirty to one hundred percent (30-100%) or more being realized.

Turning now to the further alternative exemplary embodiment of FIG. 14, there is shown an overall fuel enhancement system 620 installed in a direct-injection engine context and generally including a diesel tank 630 with a lift pump 632 and a pressurized hydrogen tank 640 both eventually feeding into a first circulation loop generally designated 650 and including an at least one straight through-flow infusion tube 670 as generally shown in FIG. 13, the circulation loop 650 being in fluid communication with a second common rail circulation loop generally designated 680 and, ultimately, the engine's injection system header 690, here by way of an inlet pressure regulator 699 and injection pump 695. In more detail, the diesel tank 630 supplies diesel fuel by way of the lift pump 632 at about 5-10 psi. The diesel fuel then passes to an optional digital diesel flow meter 635, next to a first variable area flow meter 636, more about which is said below, and then on to a further optional second variable area flow meter 637, before next passing through an optional filter and water separator unit 638 and one or more circulation pumps generally designated 634 that take the diesel fuel up to approximately 100 psi in the exemplary embodiment. It will again be appreciated that the one or more circulation loop delivery pumps 634 may be any fluid pump now known or later developed and configured for appropriate pressures and power draw and to accommodate diesel and other such light oil fuels. In the alternative embodiment shown, four such pumps in series, ganged in pairs of two with or without corresponding pressure regulators, may be used to step the pressure up from roughly 10 psi first to 60 psi and then to 100 psi, with any such pumps and pump set-ups now known or later developed being possible within the fuel enhancement system 620 of the present invention. More generally, it will be appreciated that such components, whether factory-installed or dictated by other factory-installed equipment, can vary depending on the context, namely, the style of diesel or other engine on which the fuel enhancement system is operably installed, such that the invention is to be understood as not being so limited, the details of such components being contextual and illustrative only. Back to the fuel enhancement system 620, in the exemplary embodiment there is provided a fuel filter 639 and check valve in the line downstream of the circulation pumps 634 and upstream of the intersection with a fuel line 651 that is the return from the injection pump 695 and injector spill ports and forms part of the second common rail circulation loop 680. Into this same line 651 is fed hydrogen gas from tank 640 via line 641 in which is installed an on/off solenoid valve 644 and one or more check valves and a hydrogen flow meter 646. As such, under the control of the first variable area flow meter 636, alone or in combination with data from the separate hydrogen flow meter 646, the solenoid valve 644 switches on and off to intermittently pulse or supply hydrogen through fuel line 641 to the fuel line 651 carrying diesel fuel as supplied by the tank 630 and any fuel being returned from the engine. Once more, preferably the hydrogen tank 640 is regulated to a minimum pressure of at least approximately 10 psi greater than the pressure in the fuel line 641 into which the hydrogen is feeding, and consequently fuel line 651, here on the order of 100 psi, such that the hydrogen is in-fed at approximately 110-125 psi. The solenoid flow control valve 644 is controlled by a microprocessor control 645 or the like, which receives inputs from, among other things, the one or more sensors 642 of the first variable area flow meter 636, which control 645 again may be any such device now known or later developed for electrically controlling valves or other such flow control devices and may act on data received from a variety of inputs including but not limited to the first variable area flow meter 636. By way of further example, in conjunction with a PLC (programmable logic controller) or the like, a timing circuit could be employed to control the actual “on” times or pulse lengths, or even apart from a PLC a bank of timers may be used, one setting the “open” time of the valve 644, for example two seconds, and a second timer setting a delay to block the first timer and thus prevent over-saturation; for example, no more than two seconds of gas release every twenty seconds, regardless of the diesel flow (the diesel demanded by the engine), which 2:20 ratio (time on to time off) would be an exemplary gas pulse setting at a nominal system pressure on the order of 100-150 psi. By way of further example, in some contexts it may be preferable to have the gas in-feed set to smaller, more frequent bursts; for example a one second burst every ten seconds or a half second burst every five seconds. Moreover, in other embodiments, based on data from a digital diesel flow meter 635, variable-area flow meter 636, or the like, the controller 645 can move the gas in-feed scheme up and down the scale or even vary the scale depending on diesel flow rate so as to allow for longer and/or more frequent gas pulses based on engine demand (i.e., the rate of fuel consumption). It will be appreciated that the benefit is a relatively finely tuned liquid-gaseous fuel monitoring and metering system that helps improve combustion efficiency in combination with the other aspects of the present invention. Specifically, by properly proportioning the gaseous fuel component relative to the liquid, as again by the frequency and duration of the gas in-feed pulses, the downstream pumps are able to effectively “digest” the gas and forward the pressurized mixture for further processing, namely, homogenization in the one or more circulation loop infusion tubes 670. Further regarding the illustrated control hardware of the fuel enhancement system 620 of FIG. 14, the first variable area flow meter 636 is equipped with one or more Hall effect sensors 642, optical sensors, “reed switches,” or the like for detecting the position of a float (plunger, ball, or the like) within the slightly tapered or stepped bore of the meter 636 relative to pre-determined set points. These set points are identified as relating to levels of diesel fuel flow in response to engine demand at which the gaseous pulsing as controlled by the solenoid valve 644 and processor 645 should be turned on or off for the purpose of balancing the ratio or concentration of the hydrogen gas within the diesel at any given time. For example, along a flow meter of sufficient length, there could be up to thirty-two sensors or set points, which is typically the number of I/O (input/output) ports on a PLC. It is noted that a tapered or stepped “float-type” variable area flow meter 636 as described in use here provides for higher resolution, and a plunger float is preferable over a ball so as to have sufficient frictional surface area on which the passing fluid can act, the plunger configuration providing preferable mass and surface area for flow response or meter sensitivity. The second variable area flow meter 637, together with or instead of the digital flow meter 635, may provide further confirmatory flow data and/or effectively a site glass for visual inspection of the passing fluid. If the optional hydrogen flow meter 646 is included in the fuel line 641 downstream of the solenoid valve 644, a further check on the amount of hydrogen being introduced into the fuel stream is then possible, which data can be provided to the controller 645 and used even as a safety over-ride of the first variable area flow meter 636, thereby helping to insure that not too much gas is introduced before it can be properly “digested” by the fuel enhancement system 620 and presented within the diesel fuel to the engine substantially as a liquid and so avoid pump cavitation, vapor lock of the engine, and other such problems. Once more, while a particular configuration of a flow meter 636, flow control valve 644, controller 645, and other such components, optional or otherwise, is shown and described, the invention is not so limited. Accordingly, those skilled in the art will appreciate that while an exemplary electronic metering control is shown and described in connection with the exemplary fuel enhancement system 620 of FIG. 14, the invention may instead involve any such components in a variety of combinations and configurations without departing from its spirit and scope. In the exemplary embodiment, the ratio of fuels within the fuel mixture is more than ninety percent (90%) diesel and less than ten percent (10%) hydrogen by volume at the point of mixing, assuming the mixing pressure is at a nominal 125 psi. Generally, the higher the mix pressure the higher the gaseous component ratio and hence efficiency gain, to a point, such that it will be appreciated that higher pressures within the system at or after the point of mixing may be employed without departing from the spirit and scope of the invention. It will be further appreciated by those skilled in the art that while two particular fuel constituents are described as comprising the fuel mixture, namely liquid diesel fuel and gaseous hydrogen, and within a specific proportion range, the invention is not so limited and a variety of other fuels as that term is used herein may be employed in various combinations and proportions in conjunction with a homogenizing fuel enhancement system according to aspects of the present invention without departing from its spirit and scope.

With continued reference to FIG. 14, the exemplary diesel-hydrogen fuel mixture is passed through fuel line 651 to a first high-pressure pump 692 that takes the pressure of the mixture initially up to about 400-500 psi. The fuel mixture then passes via fuel line 694 either to the remainder of the second common rail circulation loop 680 via fuel line 681 and a second high-pressure pump 693, as dictated ultimately by the demands for fuel of the engine, or on to the infusion tube circulation loop 650 by way of fuel line 652 and circulation pump 653. First, then, for all of the liquid-gaseous fuel mixture not yet required by the engine, it will be appreciated that such fuel enters the first circulation loop 650 through fuel line 652 and is there continuously circulated by pump 653 until such fuel is needed, the first circulation loop 650, in the exemplary embodiment, including at least one straight through-flow infusion tube 670 and a return line 654, though again it will be appreciated that any type and number of infusion tubes may be employed according to aspects of the present invention without departing from its spirit and scope. It will be further appreciated that in this alternate embodiment the first infusion tube circulation loop 650 is effectively maintained at 400-500 psi by virtue of the first high-pressure pump 692, with the circulation pump 653 simply maintaining the flow of the fuel through the loop 650, whereby such relatively higher circulation loop pressures further enhance the homogeneity of the fuel mixture and, accordingly, allow for relatively less infusion volume, hence the one infusion tube 670 depicted, though again more may still be employed even at the 400-500 psi circulation loop pressures. Once the multi-fuel mixture is called for by the engine it passes out of the first circulation loop 650 or directly to the second common rail circulation loop 680, the fuel then by way of fuel line 681 passes through a second high-pressure pump 693 that steps the pressure up to on the order of 4,000-10,000 psi, similar to what is often seen, even on the low end, in common rails. In fact, according to aspects of the invention in the exemplary context of a direct-injection diesel engine, a simulated common rail 682 is incorporated into the second circulation loop 680 as having its own circulation pump 683 therein and serving to circulate at maintained pressures again on the order of 4,000-10,000 psi the liquid-gaseous fuel mixture. Specifically, the fuel passes from fuel line 681 through the common rail 682 with the cooperation of circulation pump 683 and into a further fuel line 684 that then delivers the relatively high-pressure substantially homogeneous multi-fuel mixture to the inlet pressure regulator 699, again, as needed by the engine, with excess fuel simply passing along a common rail circulation line 685 and back to the common rail 682, thereby forming a part of the common rail circulation loop 680. Whereas the fuel demanded by the engine as delivered by line 684 through inlet pressure regulator 699 than passes to the injector pump 695 and then into the header 690, with spill port lines from each of the regulator 699, injector pump 695, and header 690 teeing into the other leg of the second common rail circulation loop 680, namely, fuel line 651, which then starts the whole process over of the multi-fuel mixture remaining in the second circulation loop 680 for further processing or entering the first infusion tube circulation loop 650 to be continuously re-circulated as above-described. Once again, those skilled in the art will appreciate that the configuration and number of circulation loops and pumps, high-pressure pumps, valves, connectors, and lines, the presence or absence of a heat exchange device, accumulator, or bypass line, and other such variations are possible in the fuel enhancement system 620 of the present invention without departing from its spirit and scope. Particularly, the circulation pumps 653, 683 and the high-pressure pumps 692, 693 may be of any type now known or later developed for the purpose of delivering and pressurizing the fuel mixture. Once again, since FIG. 14 is a schematic view of one fuel system embodiment according to aspects of the present invention, the relative sizes and shapes of the various components are not to be taken strictly, but instead are to be understood as being merely illustrative of the principles and features of the homogenizing fuel enhancement system of the present invention. Accordingly, the substitution of various alternative components serving substantially the same function as those shown and described is possible in the present invention and is expressly to come within its scope.

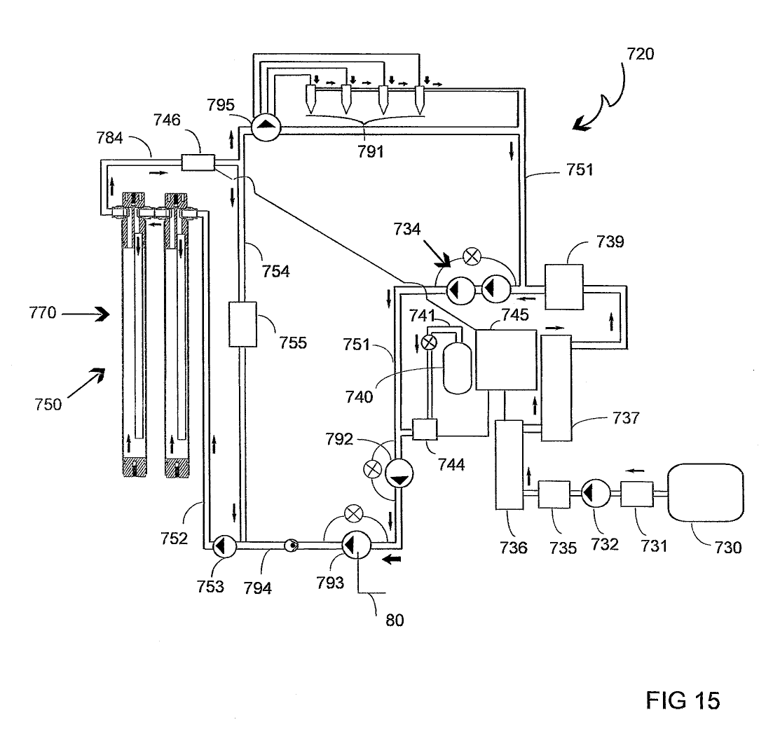

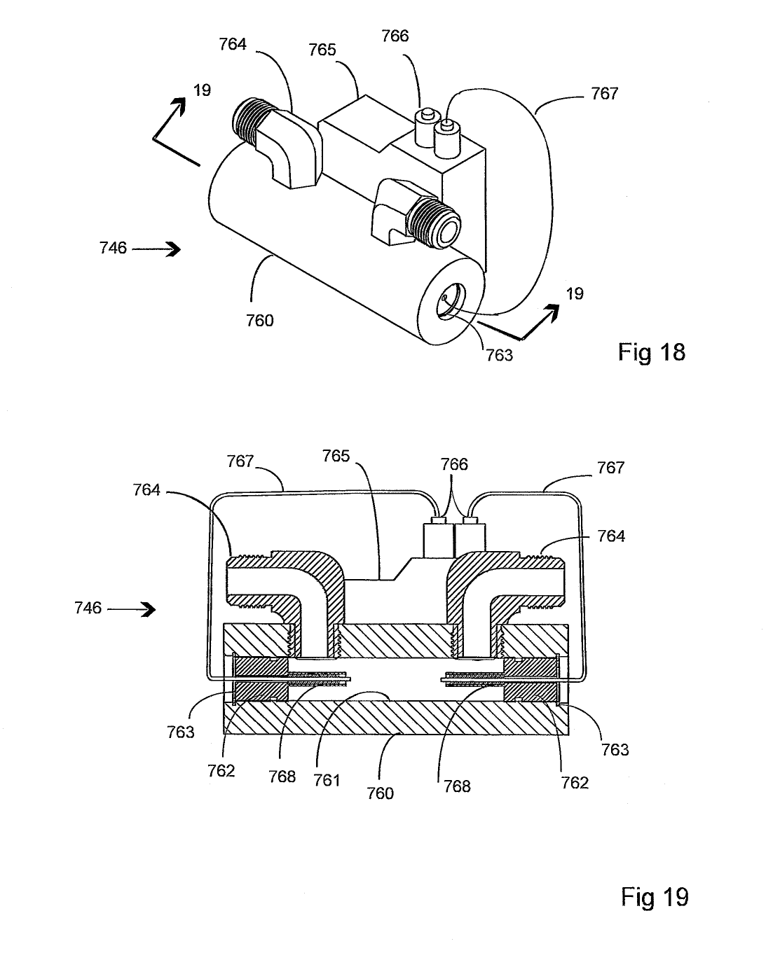

Referring now to the further alternative homogenizing fuel enhancement system 720 shown schematically in FIG. 15, here again in a direct-injection engine context only now with a relatively low-pressure set-up. The fuel system 720 again generally includes a diesel tank 730 with a lift pump 732 and a pressurized hydrogen tank 740 both eventually feeding into a circulation loop generally designated 750 and here including at least two infusion tubes 770, which are described in more detail below in connection with FIG. 16. The circulation loop 750 is again in fluid communication with the engine's injection system, here showing the actual injectors 791, by way of injection pump 795. In the exemplary embodiment, the diesel tank 730 again supplies diesel fuel by way of the lift pump 732 at about 5-10 psi, here with a first fuel filter 731 in-line immediately between the tank 730 and lift pump 732. The diesel fuel then passes to an optional digital diesel flow meter 735, next to a first variable area flow meter 736, described above in connection with FIG. 14, and then on to a further optional second variable area flow meter 737, before next passing through a second fuel filter 739 and one or more circulation pumps generally designated 734 that take the diesel fuel up to approximately 100 psi in the exemplary embodiment. It will again be appreciated that the one or more circulation loop delivery pumps 734 may be any fluid pump now known or later developed and configured for appropriate pressures and power draw and to accommodate diesel and other such light oil fuels. In the alternative embodiment shown, two such pumps in series, ganged with a corresponding pressure regulator, may be used to step the pressure up from roughly 10 psi to 100 psi, with any such pumps and pump set-ups now known or later developed being possible within the fuel enhancement system 720 of the present invention. More generally, it will be appreciated that such components, whether factory-installed or dictated by other factory-installed equipment, can vary depending on the context, namely, the style of diesel or other engine on which the fuel enhancement system is operably installed, such that the invention is to be understood as not being so limited, the details of such components being contextual and illustrative only. Back to the fuel enhancement system 720, in the alternative exemplary embodiment the second fuel filter 739 is in-line upstream of the circulation pumps 734, which are themselves downstream of the intersection with a fuel line 751 that is the return from the injection pump 795 and injector 791 spill ports and forms part of the circulation loop 750. Into this same line 751 downstream of the first group of circulation pumps 734 is fed hydrogen gas from tank 740 via line 741 in which is installed an on/off solenoid valve 744 and, optionally, one or more check valves and a hydrogen flow meter (not shown). As such, under the control of the first variable area flow meter 736, now in combination with data from the separate opacity meter 746, more about which is said below in connection with FIGS. 18 and 19, the flow control valve 744 switches on and off to intermittently pulse or supply hydrogen through fuel line 741 to the fuel line 751 carrying diesel fuel as supplied by the tank 730 and any fuel being returned from the engine. Once more, preferably the hydrogen tank 740 is regulated to a minimum pressure of at least approximately 10 psi greater than the pressure in the fuel line 741 into which the hydrogen is feeding, and consequently fuel line 751, here again on the order of 100 psi based on the configuration of pumps 734, such that the hydrogen is in-fed at approximately 110-125 psi. The solenoid flow control valve 744 is controlled by a microprocessor control 745 or the like, which receives inputs from, among other things, the one or more sensors 742 of the first variable area flow meter 736 as above-described. Once more, while a particular configuration of a flow meter 736, flow control valve 744, controller 745, and other such components, optional or otherwise, is shown and described, the invention is not so limited. Once again, the ratio of fuels within the fuel mixture is more than ninety percent (90%) diesel and less than ten percent (10%) hydrogen by volume at the point of mixing, assuming the mixing pressure is at a nominal 125 psi. Generally, the higher the mix pressure the higher the gain, to a point, such that it will be appreciated that higher pressures within the system at or after the point of mixing may be employed without departing from the spirit and scope of the invention, though as will be appreciated from other exemplary embodiments and discussion herein, it is preferable to achieve the desired homogeneous mixing using relatively lower pressures through the application of the other principles at work in aspects of the present invention as discussed herein.

With continued reference to FIG. 15, and now with further reference to FIG. 16 showing a schematic cross-sectional view of the alternative infusion tube 770 employed in the instant exemplary embodiment fuel enhancement system 720, the diesel-hydrogen fuel mixture is passed through fuel line 751 to a first lift pump 792 that takes the pressure of the mixture initially up to about 200-250 psi and then to a second lift pump 793 that takes the fuel up to about 400-500 psi. The fuel mixture then passes via fuel line 794 to the infusion tube circulation loop 750 by way of fuel line 752 and circulation pump 753. It will be appreciated that as the fuel enters the circulation loop 750 through fuel line 752 and is there continuously circulated by pump 753 until such fuel is needed, the circulation loop 750, in the exemplary embodiment, including at least two reverse-flow infusion tubes 770 and a return line 754 having a further third fuel filter 755, though again it will be appreciated that any type and number of infusion tubes and related plumbing may be employed according to aspects of the present invention without departing from its spirit and scope. In further detail, though, with reference to FIG. 16, there is shown a single reverse-flow infusion tube 770 according to further aspects of the present invention wherein the inlet tube 776 is actually now configured as the longer passage or down-tube rather than the outlet tube 76 of the infusion tube 70 of FIGS. 3-6. That is, in the alternative embodiment infusion tube 770 of FIG. 16, now the fuel mixture enters through an inlet defined by a first passage 773 formed in the upper or first end wall 772 into which the relatively longer inlet down-tube 776 is inserted, the fuel then exiting the inlet tube 776 somewhat adjacent the lower second end wall 780 and rising within the infusion tube 770 to exit through a second passage 774 formed in the first end wall 772 and thus pass on to a further infusion tube 770 or the other parts of the system 720. It will be appreciated by those skilled in the art that this alternative “reverse flow” infusion tube 770 has certain advantages in use in that, somewhat like the straight through-flow infusion tube 470 shown in FIG. 13, the infusion tube 770 is not orientation-dependent, it not being necessary that the flow of the fuel enter the main tube volume downwardly so that the bubbles attempt to rise against this down-flow and hence gravitational effects render a more vertical orientation of the tube preferable. Instead, with reference now to FIG. 17 illustrating three such “reverse-flow” infusion tubes 770 installed in series via connectors 775 interconnecting respective inlets and outlets, or first and second flow passages 773, 774, respectively, it will be appreciated that the reverse flow infusion tube 770 design is essentially velocity-dependent, reliance being had on a velocity and surface friction effect or “rub” to work in breaking apart the gas bubbles generally denoted 729 as the multi-fuel mixture flows through the tubes 770, even at closer to the general flow rate through the overall system, the relative sizes or volumes of the inlet tube 776 and that of the overall infusion tube 770 less the inlet tube 776 being substantially equivalent in the alternative exemplary embodiment so as to achieve a relatively consistent flow rate therethrough. With such a flow pattern set up, rather than any potential gas bubbles formed in the down-tube, or inlet tube 776, they would form, if at all, at the upper end of the main infusion tube volume outside the inlet tube 776 and so be “chased” forward through the rest of the infusion tubes 770 in the series, thereby helping to break up and infuse any such gas bubbles with each expansion and contraction, such that by the time the fuel mixture reaches the last infusion tube in the series, any gas bubbles are virtually non-existent, or more precisely are virtually imperceptible to the naked eye, as illustrated in FIG. 17. As another homogenizing effect in the alternative exemplary infusion tube 770, virtually regardless of orientation, the fuel exiting the inlet tube 776 has a tendency to impact the inner surface 781 of the second end wall 780 of the infusion tube 770, thereby further encouraging bubble collapse and homogeneity of the liquid-gaseous fuel mixture. Otherwise, the alternative reverse flow infusion tube 770 is constructed in much the same fashion as the other exemplary infusion tubes shown and described herein, with the first and second end walls 772 and 780 being secured in place within the respective opposite ends of the tube wall 771 employing o-rings 783 and retaining rings 779, though again any other such configuration and assembly technique now known or later developed may be employed without departing from the spirit and scope of the invention. It will be appreciated, particularly, that the configuration of the infusion tubes 770 with horizontally oriented inlet and outlet passages 773, 774 and the use of the universal connector 775 makes ganging the infusion tubes 770 or setting them up in series quite simple and space efficient without the added cost, complexity, and potential failure modes of multiple hoses and connectors or clamps, etc. It will be further appreciated that in this alternate embodiment, the infusion tube circulation loop 750 is effectively maintained at 400-500 psi by virtue of the second lift pump 793, with the circulation pump 753 simply maintaining the flow of the fuel through the loop 750, whereby such relatively higher circulation loop pressures further enhance the homogeneity of the fuel mixture and, accordingly, allow for relatively less infusion volume and/or relatively higher flow rates therethrough. In the exemplary embodiment, the overall flow rate through the system may be on the order of four gallons per minute (4 gpm). Once the multi-fuel mixture is called for by the engine it passes out of the circulation loop 750 through fuel line 784 to the injector pump 795 and then to the injectors 691, with spill port lines from each of the injector pump 795 and injectors 691 teeing into fuel line 751, which then starts the whole process over of the multi-fuel mixture passing back through the infusion tube circulation loop 750 to be continuously re-circulated as above-described. Again, those skilled in the art will appreciate that the configuration and number of circulation loops and pumps, lift pumps, valves, connectors, and lines, the presence or absence of a heat exchange device, accumulator, or bypass line, and other such variations are possible in the fuel enhancement system 620 of the present invention without departing from its spirit and scope. And since FIGS. 15-17 are schematic views of one fuel system embodiment according to aspects of the present invention, the relative sizes and shapes of the various components are not to be taken strictly, but instead are to be understood as being merely illustrative of the principles and features of the homogenizing fuel enhancement system of the present invention. Accordingly, the substitution of various alternative components serving substantially the same function as those shown and described is possible in the present invention and is expressly to come within its scope.

With continued reference to FIG. 15, and now with further reference to FIGS. 18 and 19 showing the opacity meter 746 incorporated in the alternative fuel enhancement system 720, and particularly its control system, it is first observed that the opacity meter 746 is in electrical communication with the controller 745 as are the first variable-area flow meter 736 and the gas flow control valve 744, thereby cooperating with those other two components in monitoring and controlling the rate at which gaseous fuel is added to the liquid fuel stream. Generally, the opacity meter 746 is an optical sensor configured to assess gaseous infusion based on the opacity of the mixture rather than metering the gas based only on liquid fuel flow. In other words, the opacity meter 746 acts as a refraction sensor, whereby if the fuel mixture is too refracted, indicating a high degree of gaseous or bubble content, the meter 746 in cooperation with the other control system components can shut off or prevent any further gaseous fuel in-feed, while if the fuel stream passing by or through the meter 746 is below a threshold level of refraction indicating relative homogeneity of the fluid, the meter 746 can thus allow the other control system components to continue to meter the gaseous fuel in-feed based on other system parameters such as diesel fuel flow. Accordingly, it will be appreciated that the opacity meter 746 in the exemplary embodiment is a “watch dog” on the system, and the first variable area flow meter 736, particularly, so as to over-ride that meter and prevent further gaseous fuel introduction if the fuel stream already has or appears to have a gaseous content above a threshold level despite the diesel flow rate calling for more gaseous in-feed, such as when accelerating or climbing or otherwise when the engine is under relatively high load operation. But again, when the downstream fuel mixture appears to have the gaseous fuel that has already been introduced to the diesel fuel now adequately mixed or infused therein such that the refraction or opacity levels are below the threshold value, the first variable area flow meter is thus not over-ridden, but instead triggers further gaseous in-feed as described elsewhere herein. While the opacity meter can be located in a number of places within the homogenizing fuel enhancement system 720, it is preferably located downstream of the infusion tubes 770 so as to reflect essentially the maximum degree of mixing and homogeneity that the fuel mixture is experiencing within the system 720, and on that basis ascertain whether or not the system can accommodate additional gaseous fuel in-feed. As such, as shown in FIG. 15, the opacity meter is located in fuel line 784 just after the second of the two infusion tubes 770 in the circulation loop 750 and just before the fuel mixture is passed to the injector pump 795, again, then, providing the system, and the controller 745 in electrical communication therewith, particularly, with information about the degree of homogeneity of the fuel mixture just before injection.

In more detail regarding the construction and operation of the opacity meter 746, with reference first to FIG. 18, a perspective view of an exemplary such device, the meter 746 essentially comprises a fluid flow housing 760 and an adjacent electronic housing 765. As best shown in the cross-sectional view of FIG. 19, the fluid flow housing 760 is formed with an internal bore 761 having installed at opposite ends a pair of plugs 762 retained therein using retaining rings 763 or any other such assembly means now known or later developed. A pair of connectors 764 are installed spaced apart in the wall of the fluid flow housing 760 so as to be in fluid communication with the internal bore 761 and thereby complete the flow path in and out of the fluid flow housing. As such, it will be appreciated that by simply connecting the connectors 764 to fuel lines, or splicing the opacity meter 746 within a fuel line, a complete fuel flow path is formed so as to pass through the internal bore 761 of the fluid flow housing 760. The electronic housing 765 integral with, installed on, or other substantially adjacent the fluid flow housing 760 is configured, among other things, with a pair of fiber optic connectors 766 from which extend respective fiber optic lines 767 that terminate within the internal bore 761 of the fluid flow housing 760 so as to be positioned within the fuel flow path and so define at least one optical sensor therein; more specifically and preferably, each of the two fiber optic lines 767 pass through the respective plugs 762 and extend into the internal bore 761 substantially symmetrically so as to then be positioned substantially spaced from the respective spaced apart connectors 764 through which the fuel mixture flows into and out of the fluid flow housing 760. In the exemplary embodiment, each terminal end of the fiber optic line 767 is supported by an o-ring sleeve 768 so as to leave exposed a precise length of the fiber optic line tip, which tips are substantially then pointed at each other across the fuel flow path through the fluid flow housing 760. In use, then, as the fuel mixture passes through the opacity meter 746, the fiber optic lines 767 positioned within the fuel stream as shown and described may then dynamically detect the optical quality, namely, the level of refraction, of the fuel mixture and send corresponding signals to the controller 745 with which the opacity meter 746 is in electrical communication. Once again, based on the signals thus generated and transmitted by the opacity meter 746, the controller 745, in turn, may over-ride the first variable area flow meter 736 as needed to insure that the fuel mixture ultimately being delivered to the engine is not over-saturated with gaseous fuel. Those skilled in the art will appreciate that the exemplary construction details of the opacity meter are merely illustrative of features and aspects of the invention, such that the fuel enhancement system 720, and the opacity meter 746, particularly, is not so limited, but instead may take a number of other forms incorporating technology now known or later developed without departing from the spirit and scope of the present invention. In that regard, it will be appreciated that depending on the sensor, it can be oriented either looking across a flow (much like through a sight glass) or looking along the flow axis from one end or another of a fixed length as in the exemplary embodiment, wherein either way the sensor can potentially look through several inches of fuel mixture (though particularly in the vertical or along the flow axis arrangement as shown in the exemplary embodiment) so as to view potentially more bubbles and thereby get a better sense for gas entrainment. Furthermore, the location of the opacity meter 746 can in some sense contribute to an hysteresis effect, whereby location of the meter in or after the circulation loop can have an attendant delay of the effect on the fuel at the point of mixing and that effect being seen all the way downstream, such that in some situations it may be preferable to have the opacity meter 746 relatively closer to the mixing point, but not so close that the gaseous fuel has not had time to infuse into the liquid. A still further variable on the operation of the opacity meter 746 is temperature, whereas it is known that in cold weather diesel fuel naturally has a tendency to cloud. In order to deal with possible cold-weather or cold-operating natural clouding of diesel fuel that could throw off an optical sensor, it is contemplated that, for example, temperature sensors could be employed in the system 720 and either disable the optical sensor, i.e., the opacity meter 746, during cold operation or automatically provide an offset to the triggering level to account for natural clouding of the fuel that is not to be mistaken for over-saturation of gaseous fuel within the liquid fuel. As such, again, those skilled in the art will appreciate that a number of variations on the basic opacity meter 746 are possible without departing from the spirit and scope of the invention.

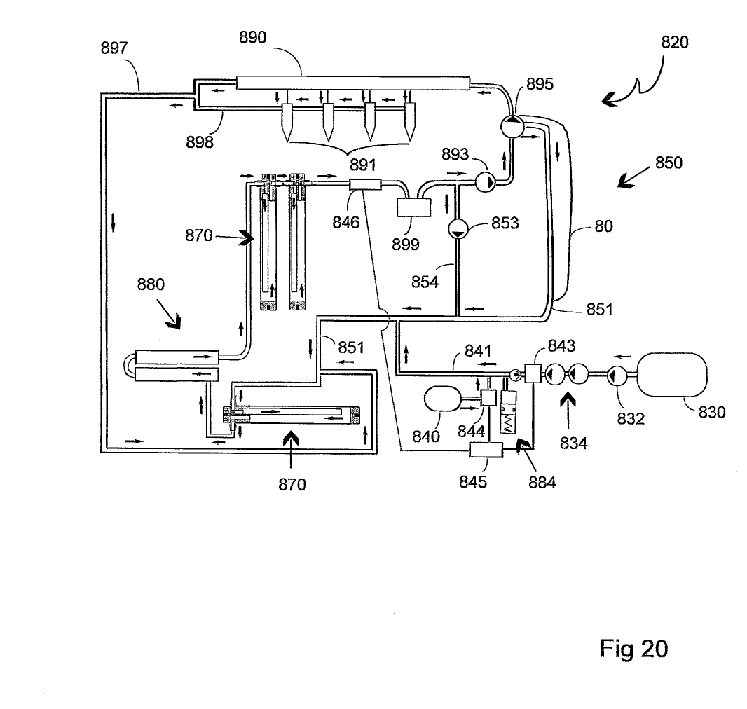

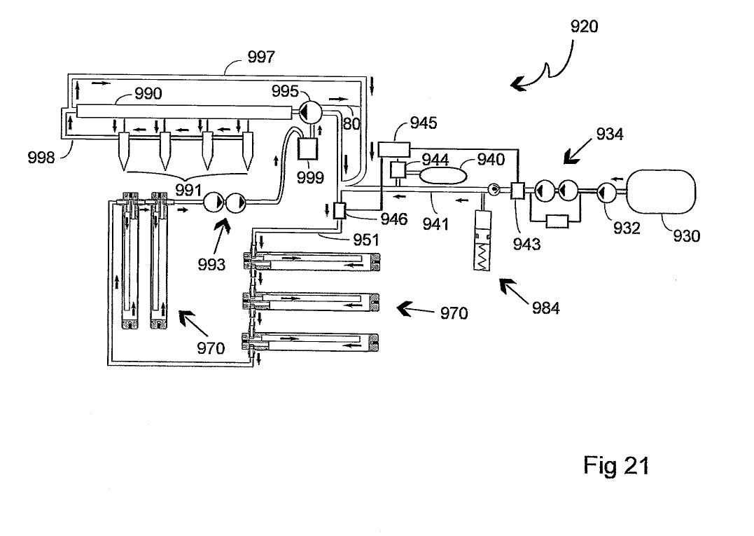

Turning briefly to FIGS. 20 and 21, there are shown still further alternative exemplary embodiments of the present invention building on and further amplifying the above description and related figures. Both such systems are in the context of a common rail diesel engine operating again at injection (common rail) pressures on the order of 25,000 psi, such as standard in a 2009 Volkswagen TDI automobile. The fuel in-feed and mixing section of each such further exemplary fuel enhancement system is much the same as the exemplary system 20 of FIG. 1, with a few exceptions as noted below. First, with reference to FIG. 20, there is shown an overall fuel enhancement system 820 generally including a diesel tank 830 with a lift pump 832 and a pressurized hydrogen tank 840 both feeding into a circulation loop generally designated 850 and here including three “reverse flow” infusion tubes 870 and two straight through-flow infusion tubes 880 all in series, more about which is said below, the circulation loop 850 once again being in fluid communication with the engine's injection system common rail 890 and injectors 891, here by way of the fuel filter 899, circulation pump 893, and injection pump 895. In more detail, the diesel tank 830 supplies diesel fuel by way of the lift pump 832 at about 5-10 psi, which then passes to one or more circulation loop delivery pumps 834 that take the diesel fuel up to approximately 100-125 psi in the exemplary embodiment. It will again be appreciated that the circulation loop delivery pump(s) 834 may be any fluid pump now known or later developed and configured for appropriate pressures and power draw and to accommodate diesel and other such light oil fuels. There is provided a flow sensor 843 in-line between the diesel tank 830 and the circulation loop 850. Additionally, the hydrogen tank 840 supplies hydrogen to a flow control valve 844 that then supplies hydrogen to the fuel line 841 carrying the diesel fuel as metered by the flow sensor 843. The flow control valve 844 is controlled by a microprocessor control 845 or the like, which control 845 may be any such device now known or later developed for electrically controlling valves or other such flow control devices and may act on data received from a variety of inputs including but not limited to the flow sensor 843 and, here, in cooperation with the flow sensor 843, a downstream opacity meter 846 as described above in connection with the exemplary embodiment of FIGS. 15, 18, and 19. In addition, an accumulator device 884 is shown as being installed in the fuel line 841 downstream of the flow meter 843, though it will be appreciated that the accumulator 884 could be anywhere in the system 820 pre-injection. Preferably, however, any such accumulator 884 will be installed in the circulation loop 850 or pre-circulation loop or otherwise on the low-pressure side of the system, or in that part of the system outside of any stepped up pressure sections of the system or the high-pressure injection system itself. As such, any residual system pressure that exists, such as when the engine is turned off and the fuel mixture is no longer circulating and which will have a tendency to seep back to the low pressure side of the system across seals, etc., it being appreciated that any static pressure differential is going to tend to have this effect and that hydrogen gas is particularly capable of penetrating and passing through most substances given enough time, particularly rubber seals and the like, will thus be taken up by the accumulator device 884 and help preserve the integrity of other system components, again, especially low-pressure components. It will thus be appreciated that while some infusion tubes may be configured with accumulators therein and some systems may not have accumulators at all, as either being sufficiently robust or operating at sufficiently low pressures or having sufficient infusion volume to accommodate such bleed-back residual system pressures, in other exemplary embodiments such as that shown in FIG. 20, there may yet be provided a low-pressure-side accumulator device 884 to further render functional the overall fuel enhancement system 820, though clearly such is not required and the invention is not so limited. Again, such a separate accumulator device 884, if included in the system 820, can be placed in a variety of locations so as to achieve the pressure relief benefits explained above. With continued reference to FIG. 20, the diesel-hydrogen fuel mixture, again, that particular fuel combination being merely illustrative, passes from fuel line 841 into line 851 of the circulation loop 850 and then on to the series of infusion tubes 870, 880. Specifically, in the exemplary embodiment, the first infusion tube 870 is a reverse flow configuration as shown and described in FIGS. 16 and 17, the second and third infusion tubes 880 are straight through-flow infusion tubes as shown and described in connection with FIG. 13, and the fourth and fifth infusion tubes 870 are again configured as the first reverse flow tube. Those skilled in the art will appreciate from the foregoing discussion and alternative exemplary embodiments presented herein that such number, configuration, and sequence of the infusion tubes 870, 880 is merely exemplary of further aspects of the present invention and is in no way limiting. Numerous other variations of the infusion tube construction and arrangement may be employed without departing from the spirit and scope of the invention. As above in connection with FIG. 15, upon exiting the last of the infusion tubes 870 in series, the fuel mixture then passes through the opacity meter 846 such that the system control is able to operate on dynamic, real-time data reflecting effectively the homogeneity of the mixture, and thus the degree to which the gaseous fuel component, in this case hydrogen, has been in-fed and whether an over-ride of the other control elements, namely, the flow control valve 844 as triggered by the diesel flow data provided by the in-line flow meter 843, so as to prevent over-saturation of the liquid fuel with gas and potentially cause system problems. From the opacity meter 846 the fuel travels though the filter 899 and then is either presented to the injection pump 895 by way of the first circulation pump 893 based on the demands of the engine or passes through a fuel line 854 located between the filter 899 and the first circulation pump 893 as circulated by a second circulation pump 853 positioned in the fuel line 854 so as to be returned to fuel line 851 for further processing through the rest of the system 820. Similarly, with reference briefly to FIG. 21, there is shown a similar overall fuel enhancement system 920 with a few notable differences as compared to FIG. 20. First, there are employed five infusion tubes 970 now all in the “reverse flow” configuration. Some are shown as horizontal and some as vertical, though it will be appreciated from the foregoing discussion that the infusion tubes 970 are generally not orientation-dependent, such that the position of any such infusion tubes 970 within an overall fuel enhancement system 920 is generally dictated by hardware and spatial constraints, for example, within an engine compartment or elsewhere on a vehicle. Further, here, the opacity meter 946, again in electrical communication with the controller 945 for the purpose of cooperating with other sensors, meters, and control devices to regulate the ration of gaseous fuel to liquid fuel, is actually downstream of the injection system, it being located in the fuel line 951 into which not only fuel mixture not needed by the injector pump 995 and spill port fuel in line 997 from the common rail 990 and injectors 991 is fed, but also new liquid-gaseous fuel mixture as delivered by fuel line 941. As such, in this exemplary embodiment, the opacity meter 946 is taking a hybrid snapshot of the fuel mixture upstream of the infusion tubes 970 as reflective of new fuel mixture combined with fuel mixture that has already been circulated at least once through the entire system. It will be appreciated that this view of the fuel mixture may not provide a view of the “best case scenario” fuel as it just exits the infusion tubes 970 or a view of the “worst case scenario” fuel as it just leaves the mixing point along fuel line 941, but instead represents an intermediate state of the fuel mixture within circulation line 951 as a type of “median” data point. Once more, though, those skilled in the art will again appreciate that the location of the opacity meter 946, and accordingly its settings, may vary from system to system without departing from the spirit and scope of the invention.

With continued reference to FIG. 21, such a homogenizing fuel enhancement system 920 was installed on a 2009 Volkswagen Jetta TDI (turbocharged 2.0-liter four-cylinder engine having a compression ratio of 16.5:1 and 140 horsepower; and a six-speed Tiptronic automatic transmission). In actual testing, a diesel-hydrogen fuel composition according to aspects of the present invention was mixed on board and utilized in the retrofitted fuel delivery system 920 according to aspects of the present invention, with the hydrogen infed at about 200 psi. The mileage test data from an independent laboratory is presented and incorporated herein by reference. Specifically, the Jetta TDI standard mileage, diesel fuel only, resulted in thirty four point six miles per gallon (34.6 mpg) where the vehicle was run without the fuel enhancement system 920 being activated at approximately fifty miles per hour (50 mph) under various loading conditions to simulate highway driving. With the Jetta TDI with the fuel enhancement system 920 then activated for a fuel composition that measured at ninety seven point eight percent by volume (97.8% vol) diesel and two point two percent by volume (2.2% vol) hydrogen, the resulting average effective mileage was found to be eighty seven point one miles per gallon (87.1 mpg), or a two hundred fifty one point seven percent (251.7%) improvement over the vehicle baseline (“diesel only” operation) of thirty four point six miles per gallon (34.6 mpg). Further tests in which the hydrogen was infed at about 375 psi again revealed significant fuel savings of the liquid diesel on the order of at least 30%. Furthermore, the 2009 Volkswagen Jetta TDI has since logged more than 5,000 miles of city and highway driving and in doing so repeatably used one (1) gallon of diesel per sixty (60) miles, with the approximate amount of hydrogen consumption of 0.02 gallon per 60 miles, and generated fuel saving of 0.54 gallons of diesel per 60 miles, which translates to roughly a sixty percent (60%) increase in fuel efficiency in an actual vehicle under actual driving conditions. Several emissions tests were also conducted at an independent smog-check station on the same 2009 Volkswagen Jetta TDI configured essentially with the fuel enhancement system 920 as shown and that resulted in the above-reported efficiency gains, and the tests revealed that the standard emission of the modified and unmodified Jetta are almost identical. The Jetta TDI equipped with the fuel enhancement system 920 and other factory emissions equipment emitted from its tailpipe 4.31 ppm hydrocarbons, 13.65% O₂, and 4.99% carbon dioxide, well below the newly imposed EPA standard for automakers, and also NOx were in a low range of on the order of 300 ppm.

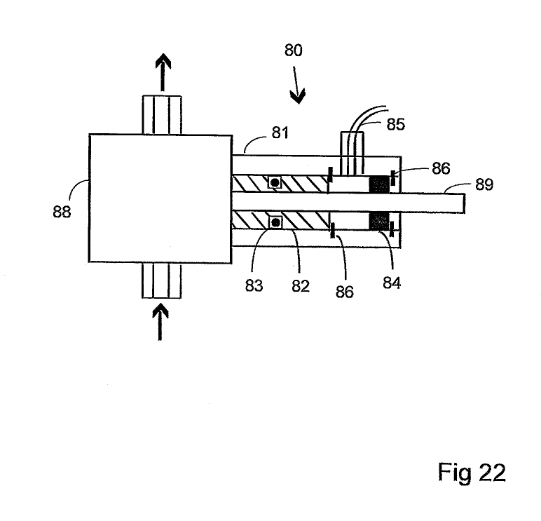

Turning finally to FIG. 22, there is shown a schematic view of an exemplary capillary bleed device 80 as employed in various fuel enhancement systems according to aspects of the present invention such as shown and described previously in connection with FIGS. 14, 15, 20 and 21. Specifically, with reference to each of those figures depicting systems 620, 720, 820, and 920, respectively, there is shown such a capillary bleed device 80 integral or employed in conjunction with the respective high-pressure pump 692, 693 (FIG. 14) and 793 (FIG. 15) or the injection pump 895 (FIG. 20) and 995 (FIG. 21). The chief purpose of the capillary bleed device 80 is to protect against pump failure, and particularly seal failure, as would be the case where a pump is used, for example, in pressures beyond what it is rated for even though it is capable of delivering or circulating such fluid pressures were it not for typically the shaft seal being the weak link, as is often the case with gear pumps particularly. Accordingly, the capillary bleed device 80 is configured about the pump shaft 89 adjacent the pump body 88 as having an outer tubular wall 81 bolted or otherwise affixed to the pump body 88 so as to be substantially concentric with the pump shaft 89 and then having a bronze bushing 82 slid therein in virtually a net-fit engagement over the shaft 89 (e.g., 0.0005″ clearance). The bronze bushing 82 further has a few thousandths clearance (e.g., less than 0.010″ clearance) with the inside surface of the tubular wall 81 and is sealed therebetween using an o-ring 83, which also serves to allow the bushing 82 to center and/or align on the pump shaft 89 with relatively little to no side load, thereby adding a degree of flexibility to the pump and motor mounts affecting the spatial position and rotation of the pump shaft 89. Opposite the bronze bushing 82 in spaced-apart relationship is the pump shaft seal 84 moved from a location along the shaft 89 within the pump housing 88, the space between the bushing 82 and the shaft seal 84 allowing for collection and bleeding off via capillary bleed line 85 of any fuel that has seeped along the pump shaft 89 between it and the bushing 82. In the exemplary embodiment, both the bronze bushing 82 and the outer shaft seal 84 are retained on the pump shaft 89 by retaining rings 86 seated within the inside surface of the outer tubular wall 81. It will be appreciated that with such a capillary bleed device 80 about the pump shaft 89 outside of or exterior to the pump housing 88, and the pump's internal shaft seal outside the housing 88 beyond the bushing 82 sealing the shaft 89, a further fail-safe for the pump's operation is thereby provided, such that even if the pump is working on fuel at on the order of 200 psi to start with or greater, with a pressure differential on the back side of the pump shaft seal, or now the bronze bushing 82, dropping to on the order of 60-100 psi, any such fuel that on that basis overcomes and seeps by the bronze bushing 82 is ultimately returned to the fuel system with the pump continuing to operate as needed. Moreover, it will be further appreciated that the aspect ratio of the bronze bushing 82, or the length of the pump shaft 89 over which the bushing 82 extends, further contributes to the sealing and slow bleed effect of the capillary bleed device 80 beneficial to the pump and its operation. Those skilled in the art will appreciate that a number of other configurations, materials, and methods of assembly now known or later developed may be employed in practicing the capillary bleed device of the present invention without departing from its spirit and scope.

In conclusion, with reference to the various exemplary infusion tube configurations shown and described herein, it is noted that the necessary or optimal infusion volume is dependent on a number of other factors, including pressure and fuel flow rate (time). Higher infusion volume can allow a proportionately, though not linearly, higher percent by volume of gaseous fuel to be sufficiently homogeneously mixed or infused within the liquid fuel, in which case the use of more infusion tubes with less time of the fuel in (or faster flow rate through) each one still allows for an effectively homogeneous multi-fuel mixture. Conversely, pressure and other factors being equal, a relatively lower total infusion volume can yet achieve the same result as the fuel is slowed within each infusion tube, whether by tube design or overall system flow rate or both. Also, not only has a geometric relationship of the length-to-diameter ratio of any given infusion tube been generally established as ranging from 2:1 to 30:1, but a further relationship embodying principles of the present invention at work has also been derived relating the total infusion volume to the engine size or displacement. Specifically, a general corollary has been established, again other factors such as pressure, temperature, flow rate, etc. being equal, wherein total infusion volume on the order 3.5 liters for every 1.0 liter of engine displacement has been found to be adequate in practicing the present invention according to the aspects shown and described herein. For example, then, for a 2.0 liter engine, the total infusion volume employed in an exemplary homogenizing fuel enhancement system was approximately 6.9 liters (1.8 gallons or 420 in³), equating to five infusion tubes having nominal dimensions of twenty-four inches (24″) in length and two inches (2″) in diameter and thereby totaling just under six liters, with the additional roughly one liter being comprised of system fuel filters and lines. Thus, a total infusion volume within the one or more infusion tubes alone at least equal to the engine displacement has been found to be sufficient to achieve the infusion and homogenization of the multi-fuel mixture according to aspects of the present invention. That is, the one or more infusion tubes of the present invention are used to promote an infusion process to form an interpenetration within the internal structure of a fuel. This effect is achieved by exposing the liquid fuel to a foreign substance such as a gas to share molecular space within the fuel, causing the gas to infuse into the liquid fuel to become effectively a composite fuel that, again, is seen by the rest of the system, and the injection system, particularly, as a liquid, even if no change on the chemical or molecular levels has occurred in any of the fuel components. As will be appreciated from the foregoing, in the infusion process the liquid-gaseous multi-fuel mixture is agitated and circulated to promote the infused particle size stability and create a unique and separate composite substance. The infusion process thus demonstrates the ability in a homogenizing fuel enhancement system according to aspects of the present invention to bind a basic gaseous fuel within a liquid fuel via primarily the one or more infusion tubes, wherein gas permeation rates change within the fuel mixture, giving the ability to selectively enhance the transport of a desired gas within the liquid fuel in relation to other factors at work such as pressure and temperature and further transport such a liquid-gaseous multi-fuel composite substance to the injection system of the engine and, ultimately, into the combustion chamber. Accordingly, the infusion tube is unique in that there is therein provided a sufficient on-board environment for the fuel additives to be homogeneously dispersed one within the other; the infusion tube creates the necessary space for the fuel mixture to be prepped prior to the injection. It will again be appreciated that such infusion tube design and underlying principles is not limited to the exemplary infusion tube constructions shown and described herein; rather, the infusion volumes, infusion tube configurations and quantities, and other system components and their relative sizes are all to be understood as merely illustrative of features and aspects of the present invention and so not limiting.

More generally, whether or not expressly called out, the fuel pumps, valves, fuel lines, and the like employed in the various embodiments of the present invention may be any such components or equipment, in any configuration, size or scale, and function, now known or later developed. Thus, while particular relative sizes of the components are shown in the drawings, these are schematics merely to illustrate the principles of the invention and so are not otherwise to be limiting in any sense.

In sum, those skilled in the art will appreciate that aspects of the present homogenizing fuel enhancement system invention involve at least one circulation loop existing outside of the injection system for continuously circulating, mixing, and maintaining the homogeneity of a multi-fuel mixture apart from any demands by or delivery to the engine's injection system (whether mechanical injection or a common rail), and at least one infusion tube configured within the at least one circulation loop for providing a volumetric expansion wherein the fuel mixture is able to infuse and thereby become more homogeneous.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A homogenizing fuel enhancement system for use in conjunction with an internal combustion engine, the engine cooperating with a liquid fuel system for controllably providing a flow of liquid fuel, and a gaseous fuel system for controllably providing a flow of gaseous fuel, the internal combustion engine being of predetermined engine displacement and having a fuel injection system, the system comprising:
a circulation system, receptive of the controlled flow of liquid fuel and the controlled flow of gaseous fuel, and disposed in fluid communication with the engine injection system, said circulation system providing a liquid-gaseous mixture of the liquid and gaseous fuels to the engine injection system and causing the liquid-gaseous mixture to traverse a circulation path within which the gaseous fuel is infused into the liquid fuel;
said circulation path providing an infusion volume through which the liquid-gaseous mixture traverses before being provided to the engine injection system, the infusion volume being at least equal to the engine displacement such that substantial homogeneity of the liquid-gaseous mixture is provided.

2. The system of claim 1 wherein the infusion volume is on the order of 3.5 times the engine displacement.

3. The system of claim 1 wherein a portion of the infusion volume is provided by at least one infusion tube disposed within the circulation path.

4. The system of claim 3 wherein the infusion tube defines an interior volume having a predetermined length and diameter, the length-to-diameter ratio of the interior volume ranging from approximately two-to-one (2:1) to approximately thirty-to-one (30:1).

5. The system of claim 3 wherein the infusion tube comprises:
a body defining an internal volume and having first and second ends disposed a predetermined axial distance apart, and
first and second passageways through the body first end operatively placing at least a portion of the internal volume within the circulation path;
the first and second passageways extending first and second predetermined axial distances into the internal volume, respectively, such distances differing by a predetermined amount such that the liquid-gaseous mixture traverses at least a defined portion the internal volume.

6. The system of claim 3 wherein a portion of the infusion volume is provided by a plurality of infusion tubes disposed in series within the circulation path.

7. The homogenizing fuel enhancement system of claim 1, wherein the circulation loop further comprises a heat exchanger.

8. The system of claim 1 wherein the circulation path includes:
a first circulation loop, receptive of the controlled flow of liquid fuel and the controlled flow of gaseous fuel;
a second circulation loop in fluid communication with the engine injection system, and with the first circulation loop.

9. The system of claim 8 further comprising an accumulator mechanism cooperating with the first and second circulation loops for compensating for pressure differentials therebetween.

10. The system of claim 8 wherein the first circulation loop includes at least one infusion tube including an interior volume providing a portion of the infusion volume.

11. The system of claim 10 wherein the first circulation loop includes a plurality of infusion tubes disposed in series.

12. The system of claim 1 wherein the cooperating gaseous fuel system controllably provides the flow of gaseous fuel in accordance with control signals applied thereto, and the fuel enhancement system comprises a sensor disposed in the circulation path for generating indicia of the relative amounts of gaseous and liquid fuels in the liquid-gaseous mixture, the control signals applied to the gaseous fuel system being generated in accordance with said indicia to vary the flow of gaseous fuel in accordance with deviations of the relative amounts of gaseous and liquid fuels in the liquid-gaseous mixture from a predetermined ratio.

13. The system of claim 1 wherein the cooperating gaseous fuel system controllably provides the flow of gaseous fuel in accordance with control signals applied thereto, and the fuel enhancement system comprises a sensor disposed in the circulation path for generating indicia of the degree of homogeneity of the liquid-gaseous mixture, the control signals applied to the gaseous fuel system being generated in accordance with said indicia to vary the flow of gaseous fuel in accordance with deviations of the degree of homogeneity of the liquid-gaseous mixture from a predetermined value.

14. The system of claim 13 wherein the sensor is an opacity meter.

15. The homogenizing fuel enhancement system of claim 1 wherein the circulation system comprises:
at least one high-pressure pump in fluid communication with said circulation path, said high-pressure pump including a pump body and a pump shaft extending therefrom; and
a capillary bleed device configured about the pump shaft adjacent the pump body as having an outer tubular wall affixed to the pump body substantially concentric with the pump shaft and further having a bushing slid therein over the pump shaft, the bushing sealed with the outer tubular wall, collection and bleeding off via a capillary bleed line intersecting the outer tubular wall of any fuel mixture that has seeped between the pump shaft and the bushing.

16. A homogenizing fuel enhancement system for use in conjunction with an internal combustion engine, the engine cooperating with a liquid fuel system for controllably providing a flow of liquid fuel, and a gaseous fuel system for controllably providing a flow of gaseous fuel in accordance with control signals applied thereto, the internal combustion engine having a fuel injection system, the system comprising:
a circulation system, receptive of the controlled flow of liquid fuel and the controlled flow of gaseous fuel, and disposed in fluid communication with the engine injection system, said circulation system providing a liquid-gaseous mixture of the liquid and gaseous fuels to the engine injection system and causing the liquid-gaseous mixture to traverse a circulation path within which the gaseous fuel is infused into the liquid fuel; and
a sensor disposed in the circulation path for generating indicia of the degree of homogeneity of the liquid-gaseous mixture in the liquid-gaseous mixture, the control signals applied to the gaseous fuel system being generated in accordance with said indicia to vary the flow of gaseous fuel in accordance with deviations of the degree of homogeneity of the liquid-gaseous mixture from a predetermined value.

17. The system of claim 16 wherein the sensor is an opacity meter.

18. The system of claim 16 wherein the circulation path includes:
a first circulation loop, receptive of the controlled flow of liquid fuel and the controlled flow of gaseous fuel; and
a second circulation loop in fluid communication with the engine injection system, and with the first circulation loop.

19. The system of claim 18 further including an accumulator mechanism cooperating with the first and second circulation loops for compensating for pressure differentials therebetween.

20. The homogenizing fuel enhancement system of claim 17, wherein the opacity meter comprises:
a fluid flow housing comprising an internal bore having installed at opposite ends a pair of plugs and having a pair of connectors installed spaced apart in the fluid flow housing so as to be in fluid communication with the internal bore and thereby complete a fuel flow path in and out of the fluid flow housing; and
an electronic housing adjacent the fluid flow housing, the electronic housing comprising a pair of fiber optic connectors from which extend respective fiber optic lines that pass through the plugs and terminate in a substantially axially offset relationship opposite one another within the internal bore of the fluid flow housing so as to be positioned within the fuel flow path and so define the optical sensor.

21. The homogenizing fuel enhancement system of claim 16 wherein the circulation system comprises:
at least one high-pressure pump in fluid communication with said circulation path, said high-pressure pump including the injection pump, each pump having a pump body and a pump shaft extending therefrom; and
a capillary bleed device configured about the pump shaft adjacent the pump body as having an outer tubular wall affixed to the pump body substantially concentric with the pump shaft and further having a bushing slid therein over the pump shaft, the bushing sealed with the outer tubular wall, collection and bleeding off via a capillary bleed line intersecting the outer tubular wall of any fuel mixture that has seeped between the pump shaft and the bushing.

22. An engine system comprising:
an internal combustion engine, the internal combustion engine being of predetermined engine displacement and having a fuel injection system;
a liquid fuel system, responsive to control signals applied thereto, for controllably providing a flow of liquid fuel;
a gaseous fuel system, responsive to control signals applied thereto, for controllably providing a flow of gaseous fuel;
a circulation system, receptive of the controlled flow of liquid fuel and the controlled flow of gaseous fuel, and disposed in fluid communication with the engine injection system, said circulation system providing a liquid-gaseous mixture of the liquid and gaseous fuels to the engine injection system and causing the liquid-gaseous mixture to traverse a circulation path within which the gaseous fuel is infused into the liquid fuel;
said circulation path providing an infusion volume through which the liquid-gaseous mixture traverses before being provided to the engine injection system, the infusion volume being at least equal to the engine displacement such that substantial homogeneity of the liquid-gaseous mixture is provided; and
a control system for generating the control signals to the liquid fuel system and gaseous fuel system.

23. The system of claim 22 wherein the control system comprises:
a sensor disposed in the circulation path for generating indicia of the relative amounts of gaseous and liquid fuels in the liquid-gaseous mixture; and
a controller for generating the control signals applied to the gaseous fuel system in accordance with said indicia, such that the gaseous fuel system varies the flow of gaseous fuel in accordance with deviations of the relative amounts of gaseous and liquid fuels in the liquid-gaseous mixture from a predetermined ratio.

24. The system of claim 22 wherein the control system comprises:
a sensor disposed in the circulation path for generating indicia of the degree of homogeneity of the liquid-gaseous mixture; and
a controller for generating the control signals applied to the gaseous fuel system in accordance with said indicia, such that the gaseous fuel system varies the flow of gaseous fuel in accordance with deviations of the degree of homogeneity of the liquid-gaseous mixture from a predetermined value.

25. For use in connection with an internal combustion engine having a fuel injection system, a method of increasing the fuel efficiency of the internal combustion engine relative to the operation of the engine upon a liquid fuel applied to the fuel injection system, comprising the steps of:
creating a controllable flow of the liquid fuel;
controllably feeding a gaseous fuel into the liquid fuel flow to form a flow of a liquid-gaseous fuel mixture for ultimate application to the engine fuel injection system;
causing the liquid-gaseous fuel mixture to flow through a circulation loop in fluid communication with the engine injection system such that the liquid-gaseous fuel mixture traverses a predetermined volume prior to application to the engine fuel injection system;
generating indicia of the degree of homogeneity of the liquid-gaseous fuel mixture in the circulation loop; and
controlling the injection of the gaseous fuel into the liquid fuel flow in accordance with the indicia of the degree of homogeneity.

26. The method of claim 25 wherein the generating indicia of the degree of homogeneity step comprises generating indicia of the opacity of the liquid-gaseous fuel mixture in the circulation loop.

27. The method of claim 25 wherein the engine has a predetermined displacement and the step of causing the liquid-gaseous fuel mixture to flow through a circulation loop comprises causing the liquid-gaseous fuel mixture to traverse a volume at least equal to the engine displacement prior to application to the engine fuel injection system.
